(19) United States
(12) Patent Application Publication
(10) Pub. No.: US 2025/0362568 A1
(43) Pub. Date: Nov. 27, 2025

(54) IMAGING LENS DRIVING MODULE, CAMERA MODULE AND ELECTRONIC DEVICE

(71) Applicant: LARGAN DIGITAL CO.,LTD., Taichung City (TW)

(72) Inventors: Yu-Tzu CHANG, Taichung City (TW); Hsiu-Yi HSIAO, Taichung City (TW)

(73) Assignee: LARGAN DIGITAL CO.,LTD., Taichung City (TW)

(21) Appl. No.: 18/908,628

(22) Filed: Oct. 7, 2024

(30) Foreign Application Priority Data
May 21, 2024 (TW) 113118798

(51) Int. Cl. G03B 13/34; G03B 30/00

(52) U.S. Cl. CPC G03B 13/34; G03B 30/00

(57) ABSTRACT

An imaging lens driving module includes an imaging lens, a lens carrier, a base, first and second balls, a focus assembly, a buffer counterpart and a flexure buffer. The lens carrier accommodates the imaging lens and includes first and second guide rails. The base includes third and fourth guide rails. The first and second balls are respectively disposed between the first and third guide rails and between the second and fourth guide rails. The focus assembly is configured to move the lens carrier. The flexure buffer is disposed on the lens carrier and/or the base. When the lens carrier is not driven by the focus assembly, the flexure buffer does not contact the buffer counterpart. The first and third guide rails each have a contact point with the first ball. The second and fourth guide rails each have a contact point with the second ball.

### RELATED APPLICATIONS

This application claims priority to Taiwan Application 113118798, filed on May 21, 2024, which is incorporated by reference herein in its entirety.

### BACKGROUND

### Technical Field

The present disclosure relates to an imaging lens driving module, a camera module and an electronic device, more particularly to an imaging lens driving module and a camera module applicable to an electronic device.

### Description of Related Art

With the development of semiconductor manufacturing technology, the performance of image sensors has been improved, and the pixel size thereof has been scaled down. Therefore, featuring high image quality becomes one of the indispensable features of an optical system nowadays. Furthermore, due to the rapid changes in technology, electronic devices equipped with optical systems are trending towards multi-functionality for various applications, and therefore the functionality requirements for the optical systems have been increasing.

However, in recent years, conventional optical systems have struggled to meet the high optical quality demands of diversified electronic products. In particular, the movement stability of the conventional optical systems during the focusing process may not satisfy the increasingly stringent market requirements for optical quality. Therefore, improving the mechanisms used in mobile optical systems to meet the high specifications of electronic devices nowadays has become a crucial issue in the relevant fields.

### SUMMARY

According to one aspect of the present disclosure, an imaging lens driving module includes an imaging lens, a lens carrier, a base, a plurality of balls, a focus assembly, at least one buffer counterpart and at least one flexure buffer. The imaging lens has an optical axis. The lens carrier accommodates the imaging lens and includes a first guide rail and a second guide rail. The first guide rail extends in a direction parallel to the optical axis, and the first guide rail has a second surface. The second guide rail extends in a direction parallel to the optical axis, and the second guide rail has a fourth surface. The base is disposed corresponding to the lens carrier, and the base includes a third guide rail and a fourth guide rail. The third guide rail extends in a direction parallel to the optical axis, the third guide rail has a fifth surface and a sixth surface, and the fifth surface and the sixth surface are connected and form an included angle. The fourth guide rail extends in a direction parallel to the optical axis, the fourth guide rail has a seventh surface and an eighth surface, and the seventh surface and the eighth surface are connected and form an included angle. The balls are disposed between the lens carrier and the base, and the balls are configured to provide the lens carrier with a degree of freedom for movement along a direction parallel to the optical axis. The balls include at least one first ball and at least one second ball. The at least one first ball is disposed between the first guide rail and the third guide rail, and the at least one second ball is disposed between the second guide rail and the fourth guide rail. The focus assembly is configured to drive the lens carrier to move in a direction parallel to the optical axis relative to the base so as to achieve focusing of the imaging lens. The at least one flexure buffer is disposed corresponding to the at least one buffer counterpart, and the at least one flexure buffer is disposed on at least one of the lens carrier and the base. The at least one flexure buffer is flexible to mitigate an impact of bumping between the at least one flexure buffer and the at least one buffer counterpart through its flexure when the lens carrier moves in a direction parallel to the optical axis. The at least one first ball includes a first center, the at least one second ball includes a second center, the first center and the second center are connected to form a first connection line on a plane perpendicular to the optical axis, and the first connection line has a first midpoint. Preferably, when the lens carrier is driven by the focus assembly to move relative to the base, a stopper portion of the at least one flexure buffer is configured to physically contact the balls to restrict the movement of the balls within a certain range. When the lens carrier is not driven by the focus assembly, the at least one flexure buffer and the at least one buffer counterpart are spaced apart from each other without physical contact therebetween. The fifth surface is located closer to the first midpoint than the sixth surface, and the seventh surface is located closer to the first midpoint than the eighth surface. The second surface, the fifth surface and the sixth surface each have a contact point with the at least one first ball, and the fourth surface, the seventh surface and the eighth surface each have a contact point with the at least one second ball. When an angle between the fifth surface and the seventh surface is θ₅₇, and an angle between the sixth surface and the eighth surface is θ₆₈, the following condition is satisfied: |θ₅₇−π|≤ |θ₆₈−π|. Preferably, the fifth surface and the seventh surface are parallel to each other.

According to another aspect of the present disclosure, an imaging lens driving module includes an imaging lens, a lens carrier, a base, a plurality of balls, a focus assembly, at least one buffer counterpart and at least one flexure buffer. The imaging lens has an optical axis. The lens carrier accommodates the imaging lens and includes a first guide rail and a second guide rail. The first guide rail extends in a direction parallel to the optical axis, and the first guide rail has a second surface. The second guide rail extends in a direction parallel to the optical axis, and the second guide rail has a fourth surface. The base is disposed corresponding to the lens carrier, and the base includes a third guide rail and a fourth guide rail. The third guide rail extends in a direction parallel to the optical axis, the third guide rail has a fifth surface and a sixth surface, and the fifth surface and the sixth surface are connected and form an included angle. The fourth guide rail extends in a direction parallel to the optical axis, the fourth guide rail has a seventh surface and an eighth surface, and the seventh surface and the eighth surface are connected and form an included angle. The balls are disposed between the lens carrier and the base, and the balls are configured to provide the lens carrier with a degree of freedom for movement along a direction parallel to the optical axis. The balls include at least one first ball and at least one second ball. The at least one first ball is disposed between the first guide rail and the third guide rail, and the at least one second ball is disposed between the second guide rail and the fourth guide rail. The focus assembly is configured to drive the lens carrier to move in a direction parallel to the optical axis relative to the base so as to achieve focusing of the imaging lens. The at least one flexure buffer is disposed corresponding to the at least one buffer counterpart, and the at least one flexure buffer is disposed on at least one of the lens carrier and the base. The at least one flexure buffer is flexible to mitigate an impact of bumping between the at least one flexure buffer and the at least one buffer counterpart through its flexure when the lens carrier moves in a direction parallel to the optical axis. The at least one first ball includes a first center, the at least one second ball includes a second center, the first center and the second center are connected to form a first connection line on a plane perpendicular to the optical axis, and the first connection line has a first midpoint. When the lens carrier is not driven by the focus assembly, the at least one flexure buffer and the at least one buffer counterpart are spaced apart from each other without physical contact therebetween. The fifth surface is located closer to the first midpoint than the sixth surface, and the seventh surface is located closer to the first midpoint than the eighth surface. The second surface, the fifth surface and the sixth surface each have a contact point with the at least one first ball, and the fourth surface, the seventh surface and the eighth surface each have a contact point with the at least one second ball. When an angle between the fifth surface and the seventh surface is θ₅₇, and an angle between the sixth surface and the eighth surface is θ₆₈, the following condition is satisfied: |θ₅₇−π|≤|θ₆₈−π|.

According to another aspect of the present disclosure, a camera module includes one of the aforementioned imaging lens driving modules and an image sensor disposed on an image surface of the imaging lens driving module.

According to another aspect of the present disclosure, an electronic device includes the aforementioned imaging lens driving module.

### BRIEF DESCRIPTION OF THE DRAWINGS

The disclosure can be better understood by reading the following detailed description of the embodiments, with reference made to the accompanying drawings as follows:

FIG. 1 is a perspective view of a camera module according to the 1st embodiment of the present disclosure;

FIG. 2 is an exploded view of the camera module in FIG. 1;

FIG. 3 is another exploded view of the camera module in FIG. 1;

FIG. 4 is a perspective view of the camera module in FIG. 1 with a cover omitted;

FIG. 5 is a top view of the camera module in FIG. 1;

FIG. 6 is a top view of the camera module in FIG. 1 with the cover omitted;

FIG. 7 is a front view of the camera module in FIG. 1 with the cover omitted;

FIG. 8 is a cross-sectional view of the camera module taken along line 8-8 in

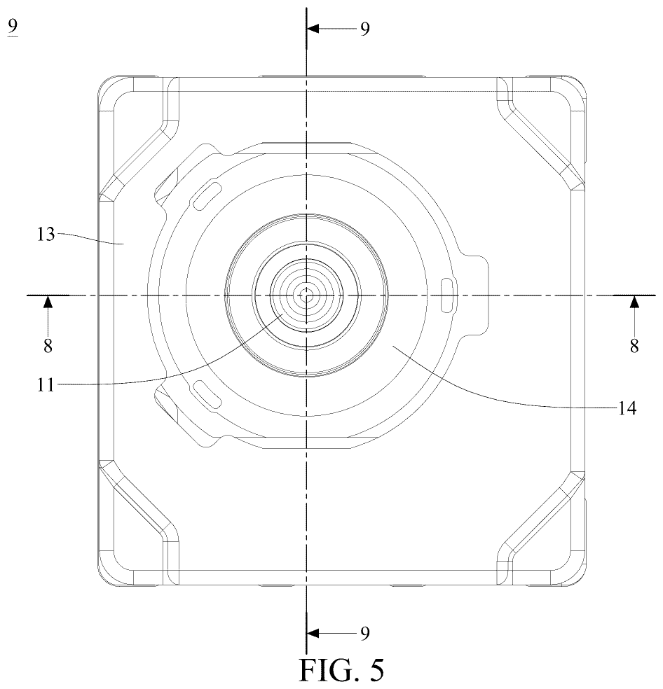

FIG. 5;

FIG. 9 is a cross-sectional view of the camera module taken along line 9-9 in FIG. 5;

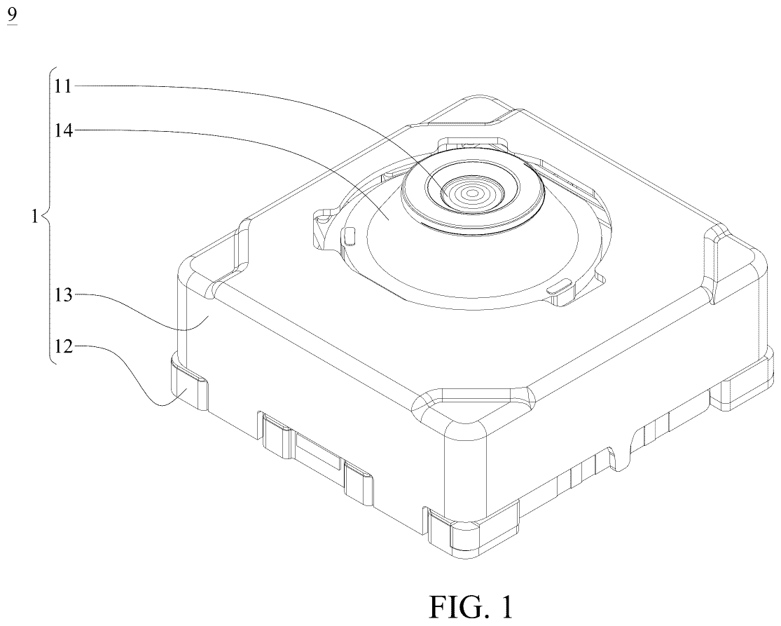

FIG. 10 is a perspective view of a base and flexure buffers of the camera module in FIG. 1;

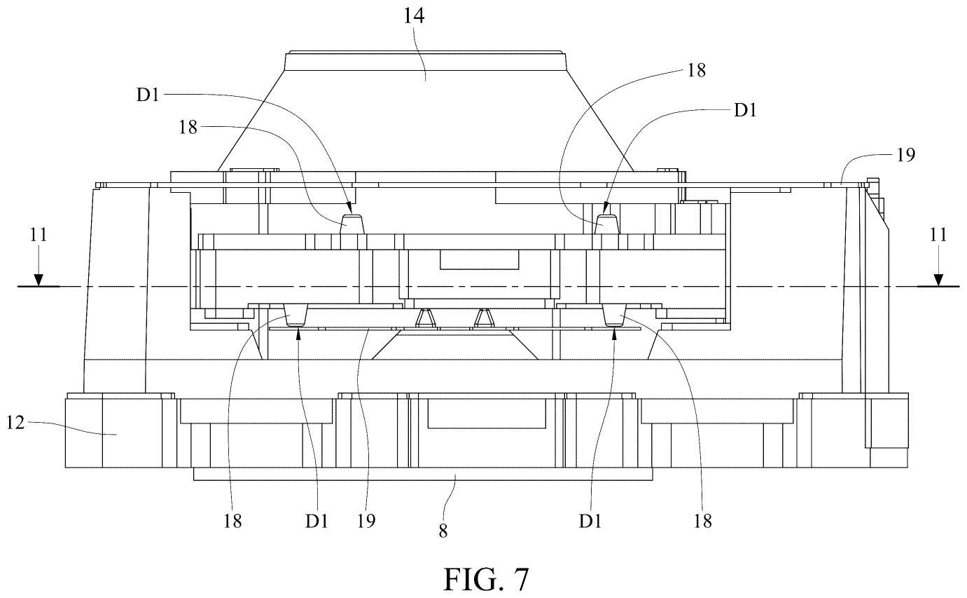

FIG. 11 is a cross-sectional view of the camera module taken along line 11-11 in FIG. 7;

FIG. 12 is a rotated view of the camera module in FIG. 11;

FIG. 13 is an enlarged view of regions EL1 and EL2 in FIG. 12;

FIG. 14 is a schematic view of the positional relationship between rails and balls in the camera module of FIG. 12;

FIG. 15 is a cross-sectional view of the positional relationship between the balls, a lens carrier and a base of the camera module according to an exemplary configuration of the present disclosure;

FIG. 16 is a cross-sectional view of the positional relationship between the balls, a lens carrier and a base of the camera module according to an exemplary configuration of the present disclosure;

FIG. 17 is an enlarged view of regions EL3 and EL4 in FIG. 16;

FIG. 18 is an exploded view of some components of a camera module according to the 2nd embodiment of the present disclosure;

FIG. 19 is another exploded view of the camera module in FIG. 18;

FIG. 20 is a front view of some components of the camera module according to the 2nd embodiment of the present disclosure;

FIG. 21 is a perspective view of the positional relationship between an imaging lens, a lens carrier and flexure buffers in the camera module of FIG. 19;

FIG. 22 is an exploded view of some components of a camera module according to the 3rd embodiment of the present disclosure;

FIG. 23 is another exploded view of the camera module in FIG. 22;

FIG. 24 is a front view of some components of the camera module according to the 3rd embodiment of the present disclosure;

FIG. 25 is a perspective view of the positional relationship between an imaging lens, a lens carrier and flexure buffers in the camera module of FIG. 23;

FIG. 26 is an exploded view of some components of a camera module according to the 4th embodiment of the present disclosure;

FIG. 27 is another exploded view of the camera module in FIG. 26;

FIG. 28 is a front view of some components of the camera module according to the 4th embodiment of the present disclosure;

FIG. 29 is a perspective view of the positional relationship between an imaging lens, a lens carrier and flexure buffers in the camera module of FIG. 27;

FIG. 30 is an exploded view of some components of a camera module according to the 5th embodiment of the present disclosure;

FIG. 31 is another exploded view of the camera module in FIG. 30;

FIG. 32 is a cross-sectional view of some components of the camera module according to the 5th embodiment of the present disclosure;

FIG. 33 is a perspective view of the positional relationship between an imaging lens, a lens carrier and flexure buffers in the camera module of FIG. 30;

FIG. 34 is a perspective view of a cover and flexure buffers in a camera module according to the 6th embodiment of the present disclosure;

FIG. 35 is a perspective view of a cover and flexure buffers in a camera module according to an exemplary embodiment of the present disclosure;

FIG. 36 is a perspective view of an electronic device according to the 7th embodiment of the present disclosure;

FIG. 37 is another perspective view of the electronic device in FIG. 36;

FIG. 38 is an illustration of an image captured by an ultra-wide-angle camera module;

FIG. 39 is an illustration of an image captured by a high pixel camera module;

FIG. 40 is an illustration of an image captured by a telephoto camera module;

FIG. 41 is a perspective view of an electronic device according to the 8th embodiment of the present disclosure;

FIG. 42 is a perspective view of an electronic device according to the 9th embodiment of the present disclosure;

FIG. 43 is a side view of the electronic device in FIG. 42; and

FIG. 44 is a top view of the electronic device in FIG. 42.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The present disclosure provides an imaging lens driving module. The imaging lens driving module includes an imaging lens, a lens carrier, a base, a plurality of balls, a focus assembly, at least one buffer counterpart and at least one flexure buffer.

The lens carrier accommodates the imaging lens and includes a first guide rail and a second guide rail extending in a direction parallel to an optical axis of the imaging lens. In addition, the first guide rail has a second surface, and the second guide rail has a fourth surface.

The base is disposed corresponding to the lens carrier, and the base includes a third guide rail and a fourth guide rail extending in a direction parallel to the optical axis of the imaging lens. In addition, the third guide rail has a fifth surface and a sixth surface, the fifth surface and the sixth surface are connected and form an included angle, the fourth guide rail has a seventh surface and an eighth surface, and the seventh surface and the eighth surface are connected and form an included angle.

The balls are disposed between the lens carrier and the base, and the balls are configured to provide the lens carrier with a degree of freedom for movement in a direction parallel to the optical axis. Moreover, the balls include at least one first ball and at least one second ball. The first ball is disposed between the first guide rail and the third guide rail, and the second ball is disposed between the second guide rail and the fourth guide rail. In other words, the first guide rail and the third guide rail are arranged in corresponding pairs, and the second guide rail and the fourth guide rail are also arranged in corresponding pairs, which can enhance the collimation of the movement of the balls in a direction parallel to the optical axis. Moreover, the total number of the balls is at least three. For example, in one exemplary configuration of the present disclosure, the number of the first balls is at least two, and the number of the second ball(s) is at least one. However, the present disclosure is not limited thereto. In another exemplary configuration of the present disclosure, the number of the first ball(s) is at least one, and the number of the second ball(s) is at least two.

The focus assembly is configured to drive the lens carrier to move in a direction parallel to the optical axis relative to the base so as to achieve focusing of the imaging lens.

The flexure buffer is disposed corresponding to the buffer counterpart, and the flexure buffer is disposed on at least one of the lens carrier and the base. Moreover, the flexure buffer is flexible to mitigate the impact of bumping between the flexure buffer and the buffer counterpart through its flexure when the lens carrier moves in a direction parallel to the optical axis. Specifically, the flexure buffer flexes when being in physical contact with the buffer counterpart. Said flexure can refer to a case where one end of a single component is constrained, while another end bends under load, with the bent part being recoverable when the load is removed. Moreover, the flexure buffer and the buffer counterpart bump into each other, generating an impact that prevents the imaging lens from moving too quickly during the focusing process, which also reduces hitting between components such as the lens carrier and the base during focusing, thereby reducing the likelihood of abnormal noises. Moreover, when the lens carrier is not driven by the focus assembly, the flexure buffer and the buffer counterpart are spaced apart from each other without physical contact therebetween. Moreover, the flexure buffer can be made of plastic material or metal material, but the present disclosure is not limited thereto.

The first ball includes a first center, the second ball includes a second center, and the first center and the second center are connected to form a first connection line on a plane perpendicular to the optical axis. Moreover, the first connection line has a first midpoint. Please refer to FIG. 11, which shows a schematic view of the first connection line L1 and the first midpoint P1 thereof according to the 1st embodiment of the present disclosure.

The fifth surface of the third guide rail is located closer to the first midpoint than the sixth surface of the third guide rail, and the seventh surface of the fourth guide rail is located closer to the first midpoint than the eighth surface of the fourth guide rail. Please refer to FIG. 14, which shows a schematic view of the positional relationship between the first midpoint P1 of the first connection line L1 and the fifth surface S5, the sixth surface S6, the seventh surface S7 and the eighth surface S8 according to the 1st embodiment of the present disclosure.

The second surface, the fifth surface and the sixth surface each have a contact point with the first ball, and the fourth surface, the seventh surface and the eighth surface each have a contact point with the second ball.

When an angle between the fifth surface of the third guide rail and the seventh surface of the fourth guide rail is θ₅₇, and an angle between the sixth surface of the third guide rail and the eighth surface of the fourth guide rail is θ₆₈, the following condition is satisfied: |θ₅₇−π|≤|θ₆₈−π|. Please refer to FIG. 14, which shows a schematic view of θ₅₇ and θ₆₈ according to the 1st embodiment of the present disclosure.

According to the present disclosure, by ensuring that the first ball has at least one contact point with each of the first guide rail and the third guide rail, and that the second ball has at least one contact point with each of the second guide rail and the fourth guide rail, a degree of freedom for movement of the lens carrier in a direction parallel to the optical axis can be provided. Additionally, by having a suitable angle between the fifth surface and the seventh surface and a suitable angle between the sixth surface and the eighth surface, the stability of the mechanism can be enhanced, thereby improving manufacturing yield.

The flexure buffer can include a stopper portion. When the lens carrier is driven by the focus assembly to move relative to the base, the stopper portion of the flexure buffer is configured to physically contact the balls to restrict the movement of the balls within a certain range. Therefore, the stopper portion can prevent detachment of the balls from the guide rails (i.e., the first guide rail, the second guide rail, the third guide rail, and the fourth guide rail) during the movement of the lens carrier, thereby maintaining the stability of the movement of the lens carrier in a direction parallel to the optical axis.

The fifth surface and the seventh surface can be parallel to each other. Therefore, the mechanical stability can be enhanced, thereby improving manufacturing yield.

According to the present disclosure, the imaging lens driving module can further include a cover coupled to the base, the cover forms an internal space with the base, and the lens carrier is disposed within the internal space. Moreover, the lens carrier is movable in a direction parallel to the optical axis within the internal space.

The flexure buffer can further include a bumping part and a flexure part, and the buffer counterpart can include a contact part. The bumping part is configured to physically contact the contact part, the flexure part is connected to the bumping part, and the flexure part flexes when the bumping part and the contact part bump into each other. Therefore, the bumping part and the contact part bump into each other to cause flexure of the flexure part to flex, which helps mitigation of abnormal noises caused by impacts between the lens carrier and components (e.g., the base) during movement of the lens carrier in parallel to the optical axis. Moreover, the flexure part can be recoverable.

The flexure buffer can be further disposed on the cover. In one exemplary configuration, the flexure buffer and the cover are separate components assembled together, but the present disclosure is not limited thereto. In another exemplary configuration, the flexure buffer and the cover are integrally formed.

In one exemplary configuration of the present disclosure, the buffer counterpart can be disposed on the base. For example, in one exemplary configuration, the buffer counterpart and the base are separate components assembled together, but the present disclosure is not limited thereto. In another exemplary configuration, the buffer counterpart and the base are integrally formed.

In another exemplary configuration of the present disclosure, the buffer counterpart can be disposed on the lens carrier. For example, in one exemplary configuration, the buffer counterpart and the lens carrier are separate components assembled together, but the present disclosure is not limited thereto. In another exemplary configuration, the buffer counterpart and the lens carrier are integrally formed.

In another exemplary configuration of the present disclosure, the buffer counterpart can be disposed on the cover. For example, in one exemplary configuration, the buffer counterpart and the cover are separate components assembled together, but the present disclosure is not limited thereto. In another exemplary configuration, the buffer counterpart and the cover are integrally formed.

The focus assembly can include a magnet and a coil disposed corresponding to the magnet, and one of the magnet and the coil is coupled to the lens carrier. Moreover, the configuration where the magnet is coupled with the lens carrier is defined as a moving magnet drive configuration, while the configuration where the coil is coupled with the lens carrier is defined as a moving coil drive configuration.

The at least one first ball can include at least two first balls, and the at least one second ball can include at least two second balls. Therefore, a proper number of balls can improve the stability of the movement of the lens carrier.

The optical axis and the first connection line are connected to form a second connection line on a plane perpendicular to the optical axis, and the second connection line is orthogonal to and intersects both the optical axis and the first connection line. In addition, an intersection point of the first connection line and the second connection line is an eccentric point. Please refer to FIG. 11, which shows a schematic view of the first connection line L1, the second connection line L2 and the eccentric point P2 according to the 1st embodiment of the present disclosure.

In one exemplary configuration of the present disclosure, the eccentric point does not coincide with the first midpoint of the first connection line. Therefore, the eccentric design of the imaging lens allows the imaging lens driving module to be positioned at the corner of an electronic device, thereby enhancing the mechanical arrangement flexibility of the electronic device. Please refer to FIG. 11, which shows a schematic view of the eccentric point P2 and the first midpoint P1 of the first connection line L1 according to the 1st embodiment of the present disclosure.

In another exemplary configuration of the present disclosure, the eccentric point coincides with the first midpoint of the first connection line. Please refer to FIG. 15, which shows a schematic view of the eccentric point P2 and the first midpoint P1 of the first connection line L1 according to one exemplary configuration of the present disclosure.

The first guide rail can further have a first surface, and the first surface and the second surface of the first guide rail are connected and form an included angle. The second guide rail can further have a third surface, and the third surface and the fourth surface of the second guide rail are connected and form an included angle. Therefore, under a specific mechanism design, the stability of movement of the balls between the first guide rail and the third guide rail or between the second guide rail and the fourth guide rail can be improved.

The first surface of the first guide rail and the fifth surface of the third guide rail can be parallel to each other. Therefore, under a specific mechanism design, the stability of movement of the first ball between the first guide rail and the third guide rail can be improved.

The third surface of the second guide rail and the seventh surface of the fourth guide rail can be parallel to each other. Therefore, under a specific mechanism design, the stability of movement of the second ball between the second guide rail and the fourth guide rail can be improved.

There can be a gap between the first surface of the first guide rail and the first ball and/or between the third surface of the second guide rail and the second ball. In other words, there can be a gap between the first surface of the first guide rail and the first ball, or between the third surface of the second guide rail and the second ball, or both. Therefore, under a specific mechanism design, the stability of movement of the balls between the guide rails can be improved.

When an angle between the fifth surface and the sixth surface of the third guide rail is θ₅₆, the following condition can be satisfied: π/2≤θ₅₆<π. Therefore, under a specific angle, the manufacturability of the third guide rail and the first guide rail corresponding thereto can be improved. Moreover, the following condition can also be satisfied: 98 degrees≤θ₅₆<π. Please refer to FIG. 13, which shows a schematic view of θ₅₆ according to the 1st embodiment of the present disclosure.

When an angle between the seventh surface and the eighth surface of the fourth guide rail is θ₇₈, the following condition can be satisfied: π/2≤θ₇₈<π. Therefore, under a specific angle, the manufacturability of the fourth guide rail and the second guide rail corresponding thereto can be improved. Moreover, the following condition can also be satisfied: 98 degrees≤θ₇₈<π. Please refer to FIG. 13, which shows a schematic view of θ₇₈ according to the 1st embodiment of the present disclosure.

The imaging lens can include a reduced portion trimmed towards the optical axis from a part of the imaging lens, resulting in a non-circular shape of the imaging lens in a direction surrounding the optical axis. Therefore, the imaging lens can have, for example, but not limited to, an appropriately trimmed structure to meet mechanical design requirements or optical imaging demands.

According to the present disclosure, a camera module is provided. The camera module includes an image sensor and the aforementioned imaging lens driving module, and the image sensor is disposed on an image surface of the imaging lens driving module.

According to the present disclosure, an electronic device is provided. The electronic device includes the aforementioned camera module.

According to the present disclosure, the aforementioned features and conditions can be utilized in numerous combinations so as to achieve corresponding effects.

According to the above description of the present disclosure, the following specific embodiments are provided for further explanation.

### 1st Embodiment

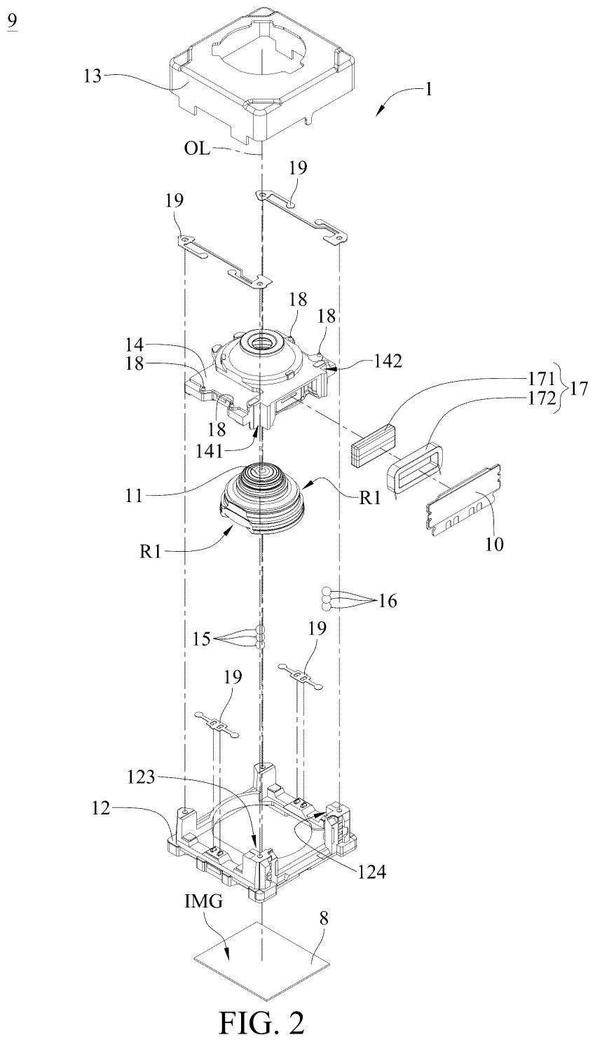

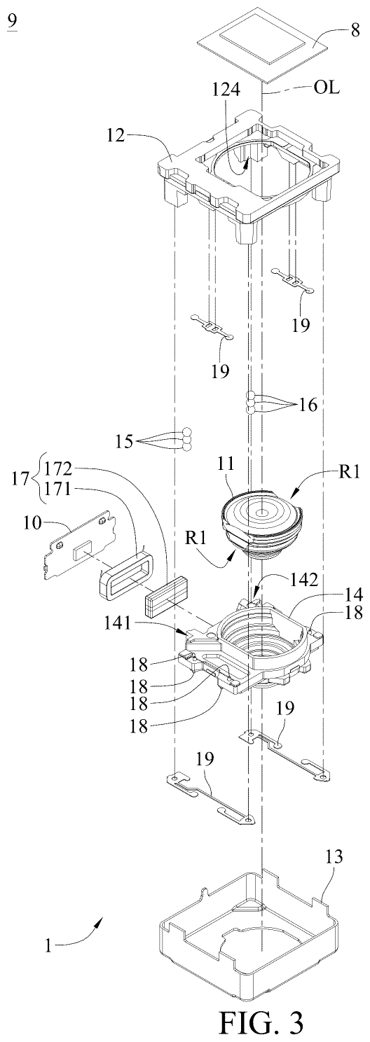

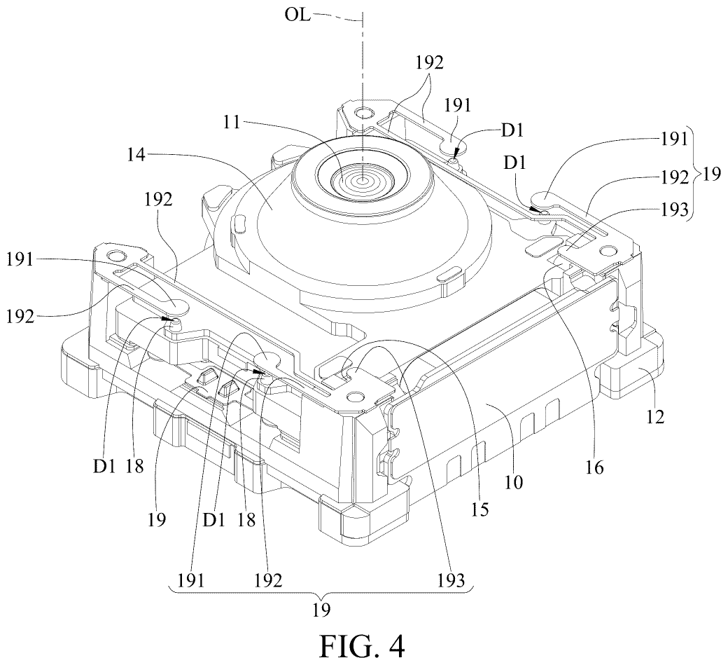

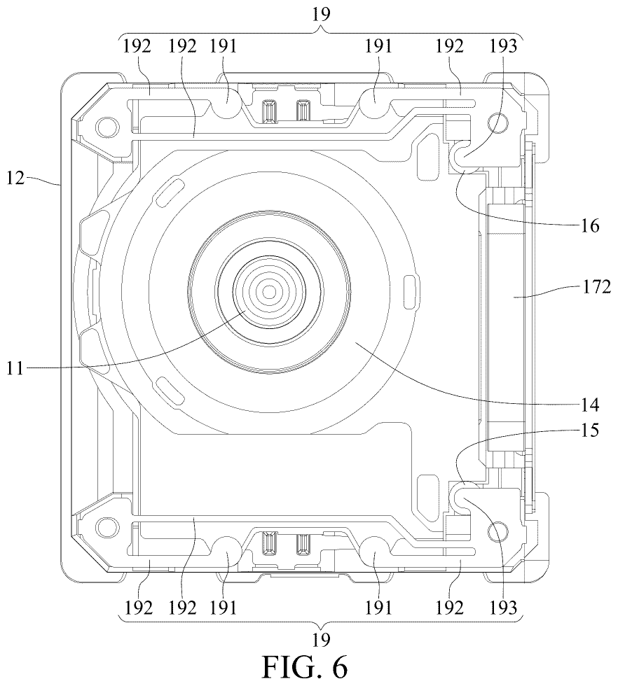

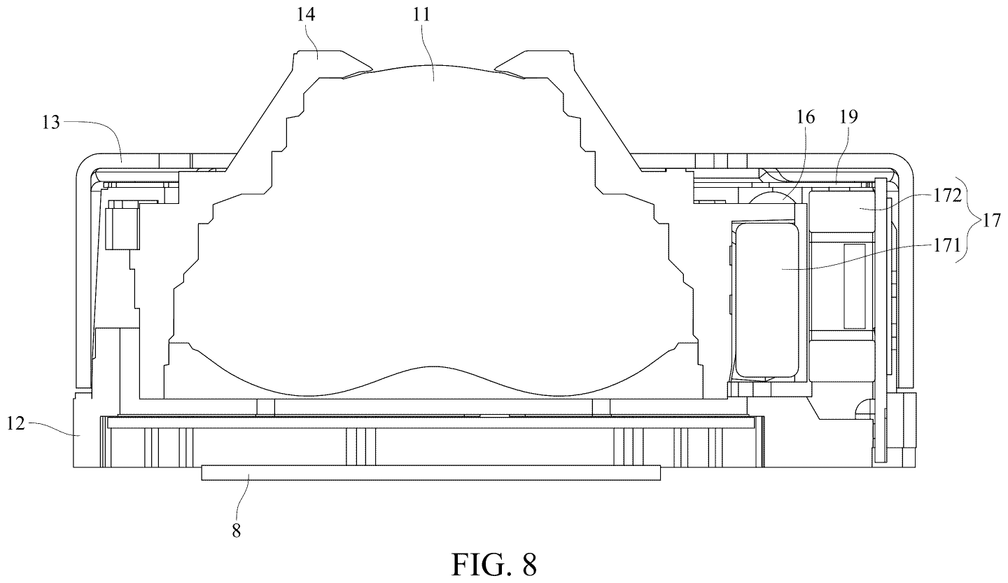

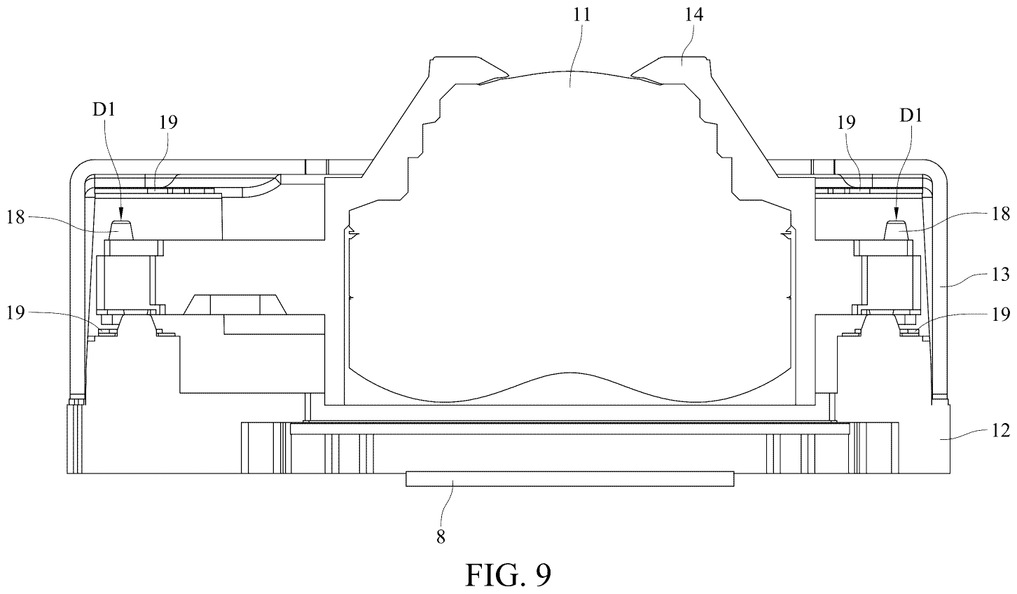

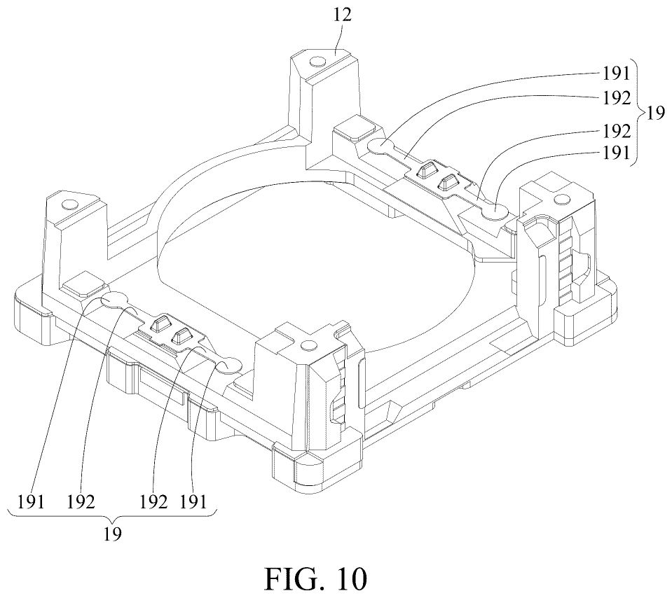

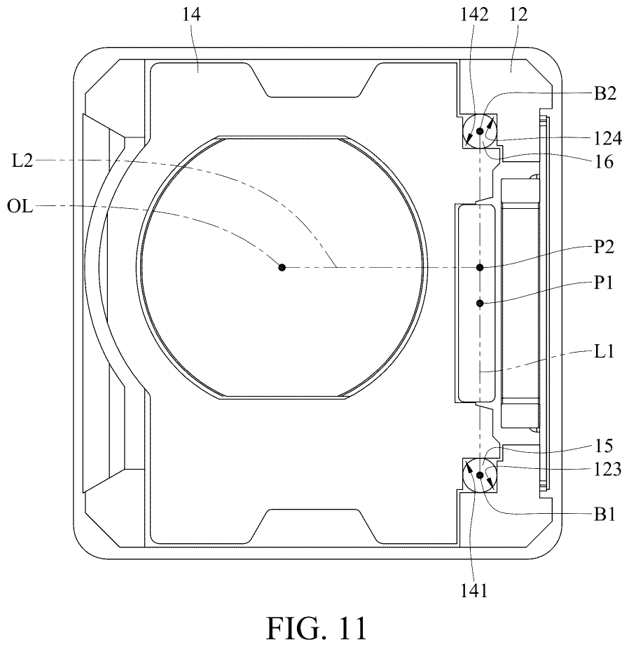

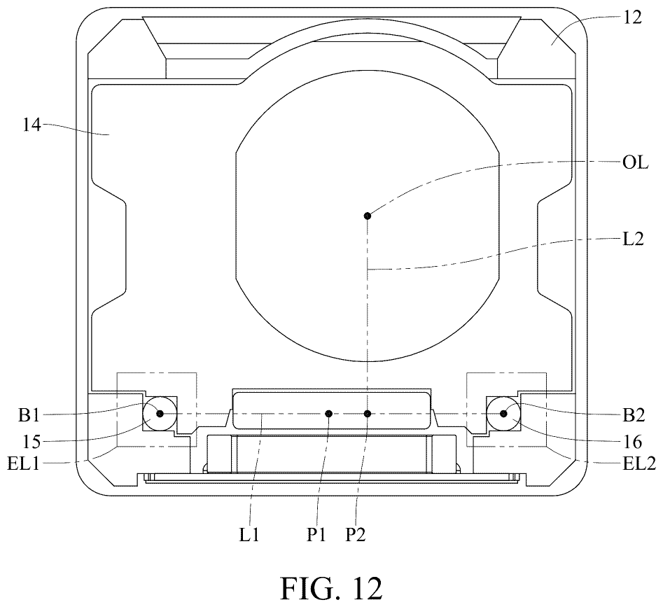

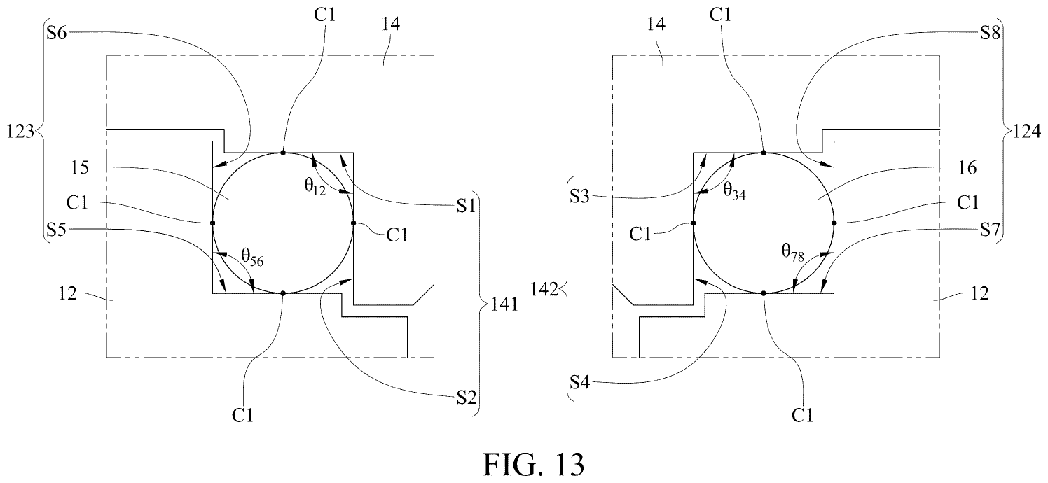

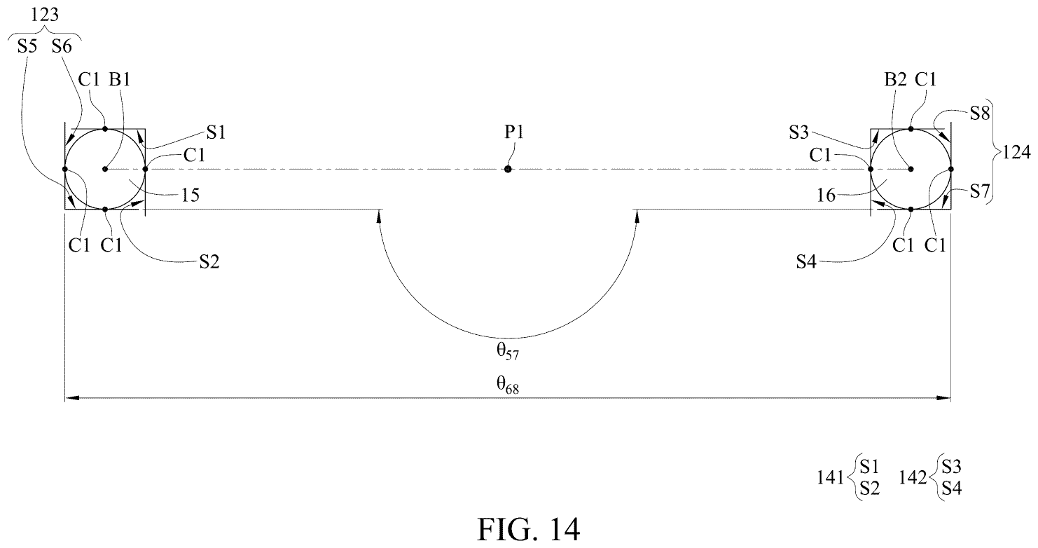

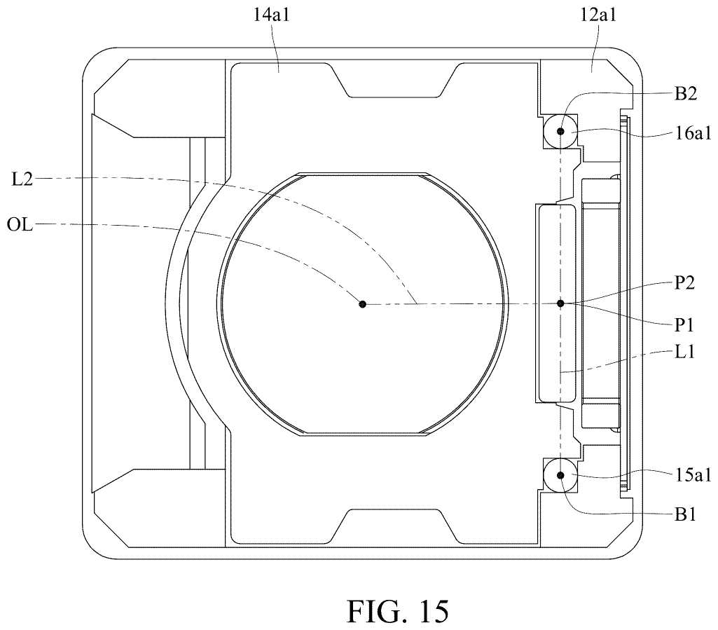

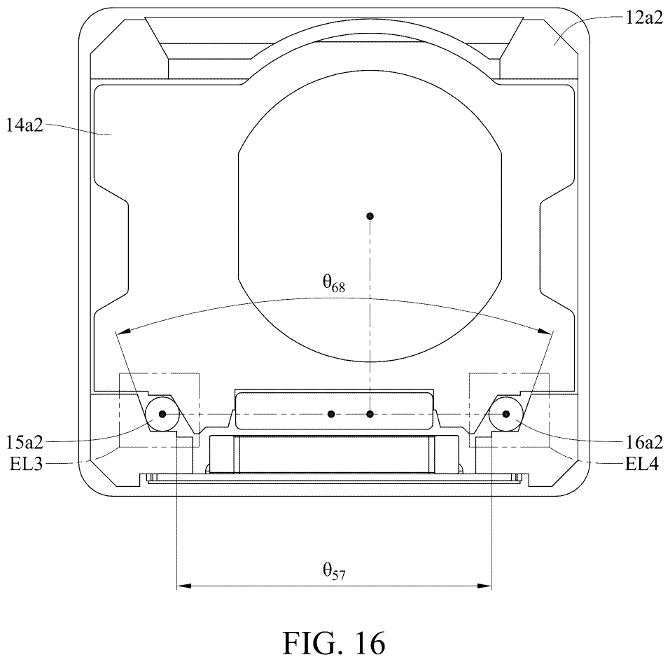

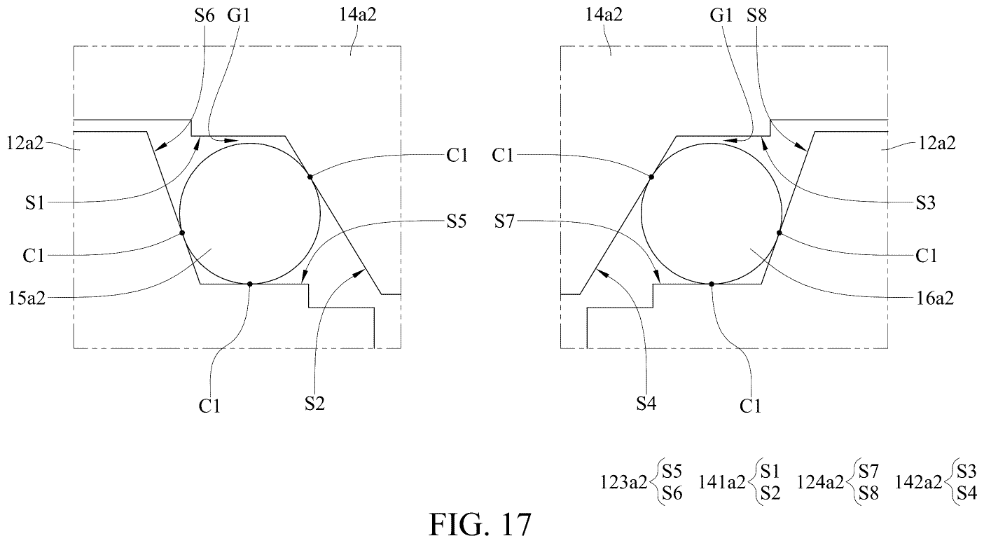

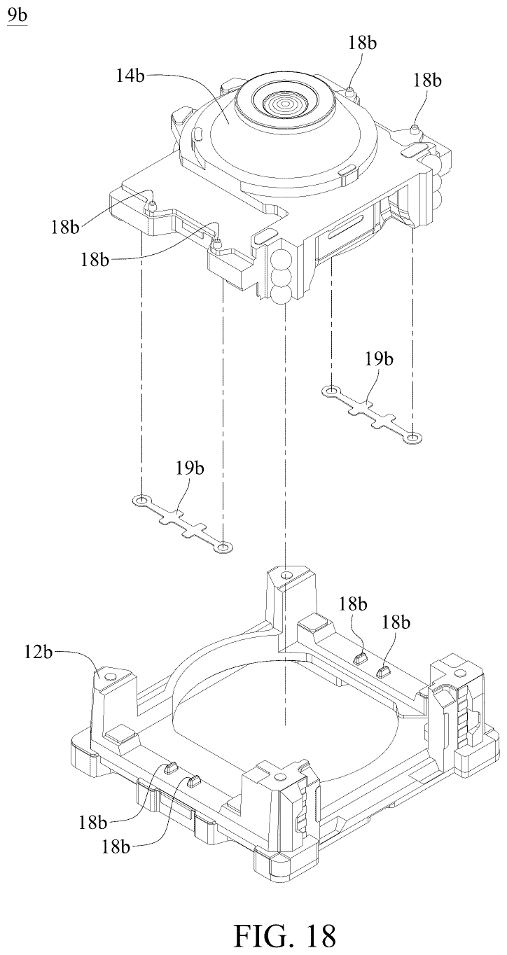

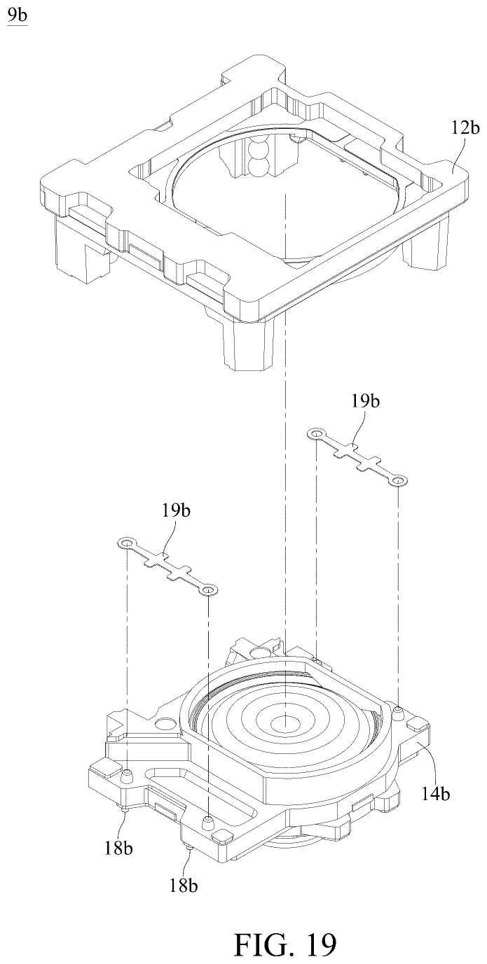

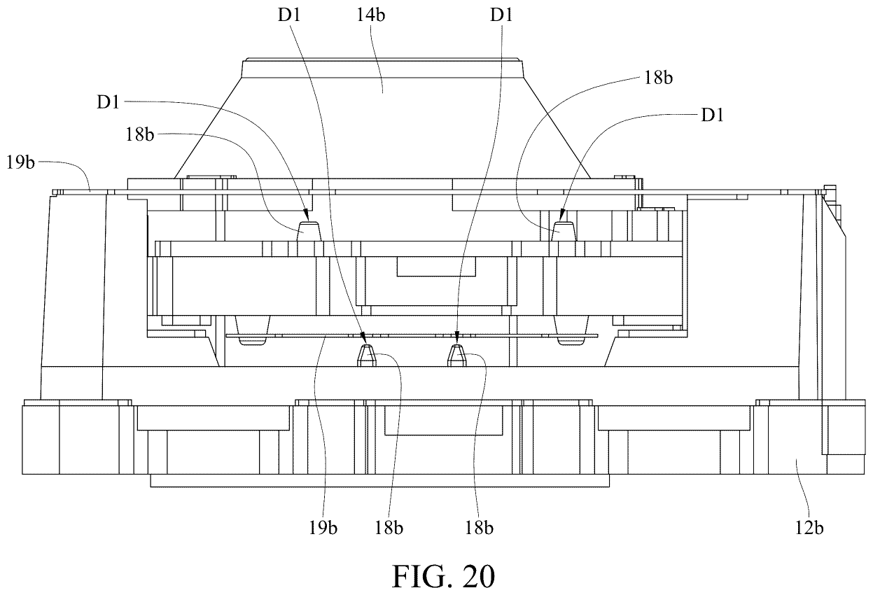

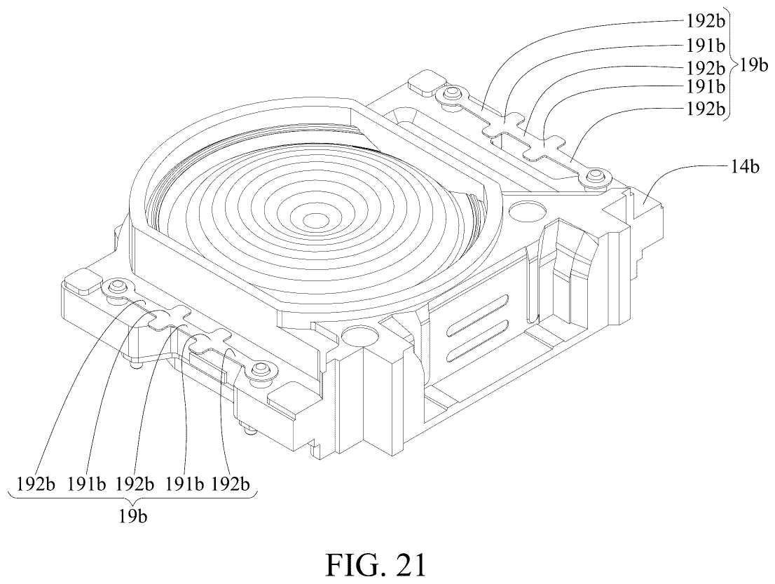

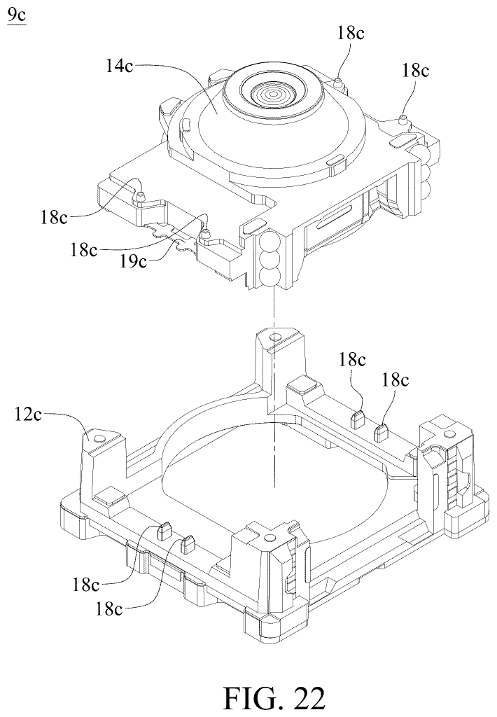

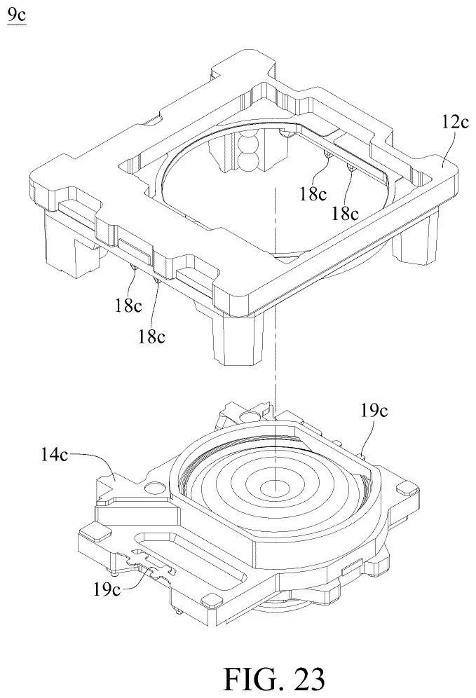

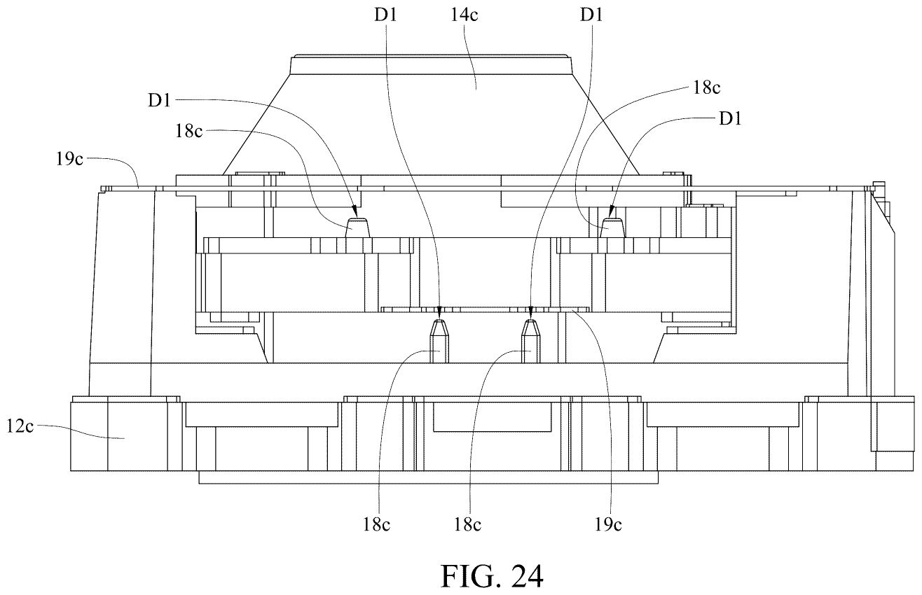

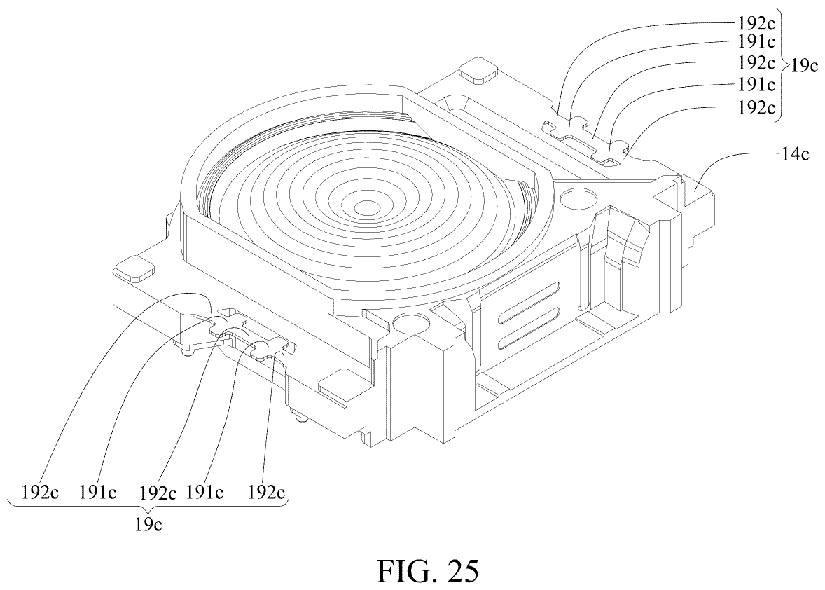

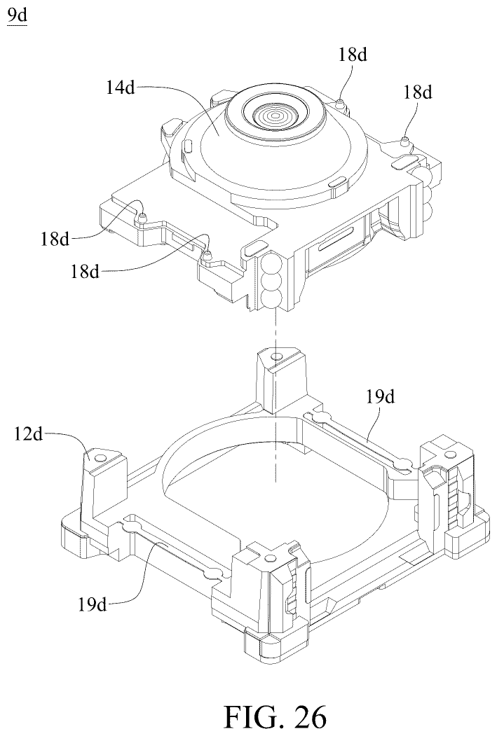

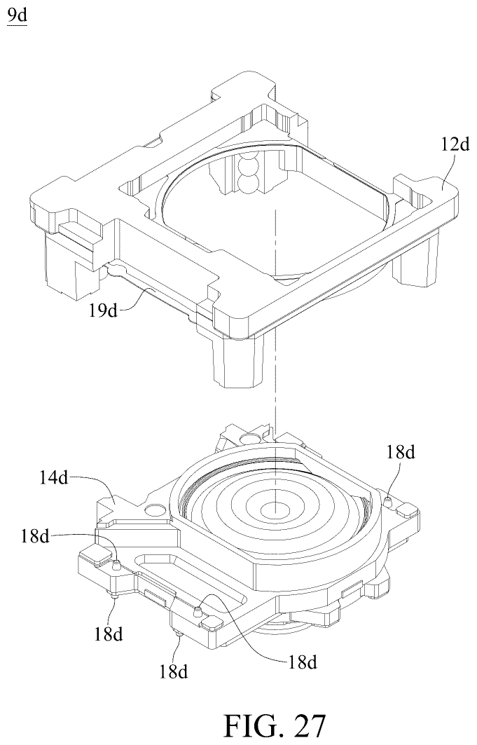

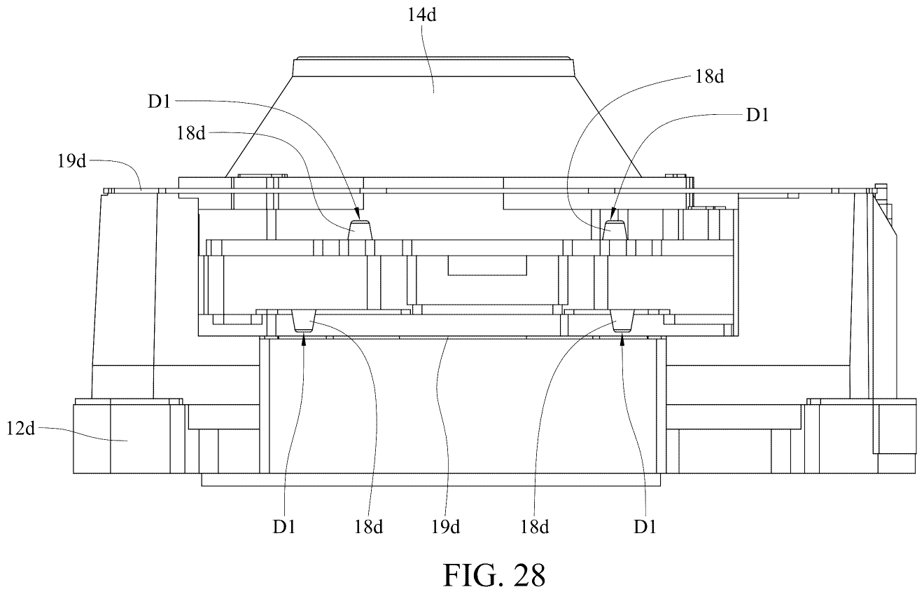

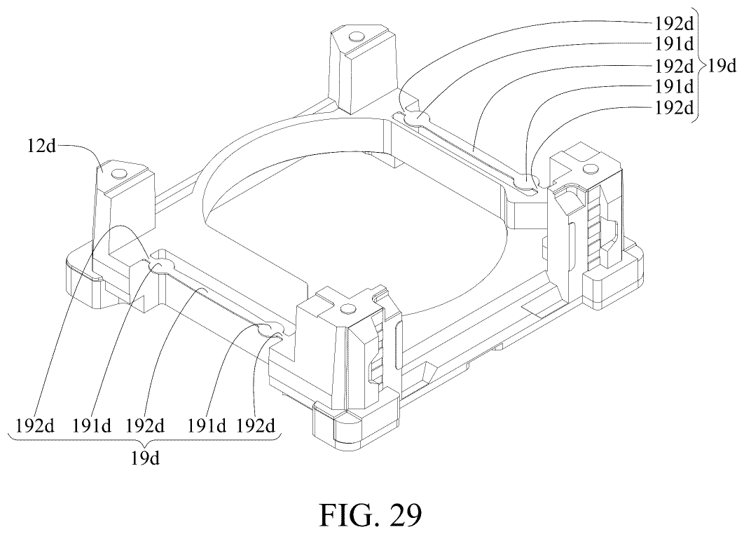

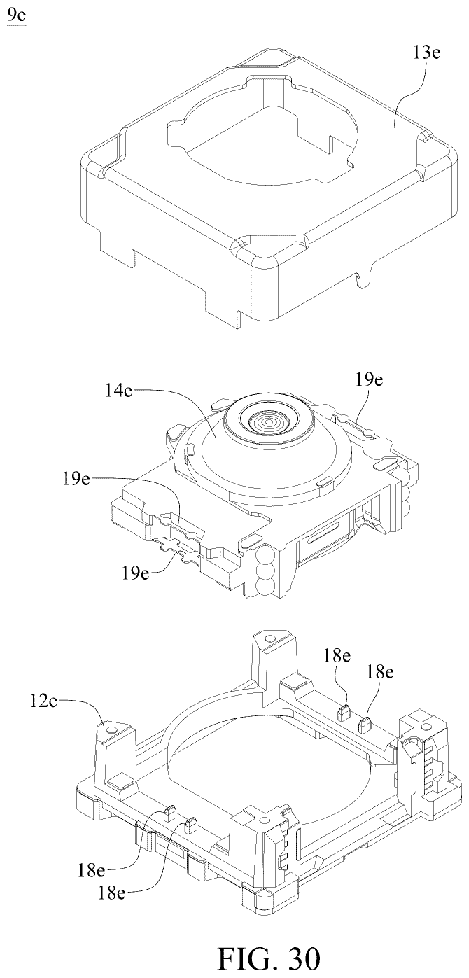

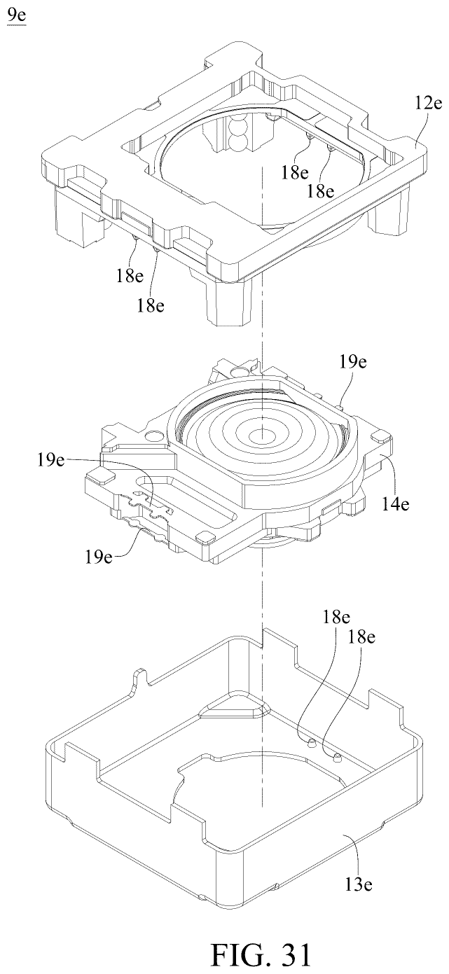

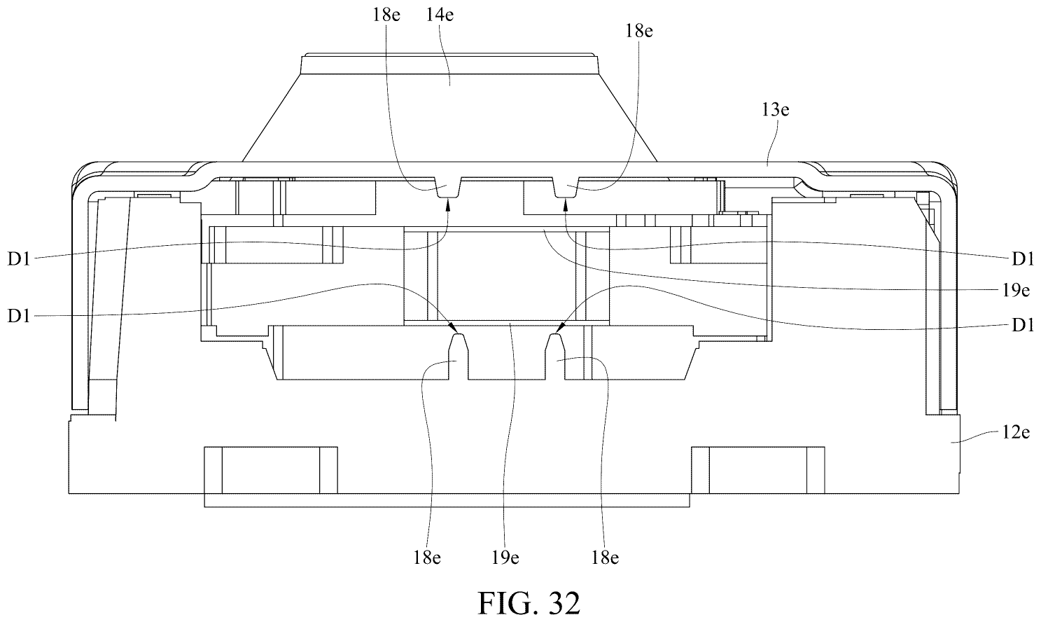

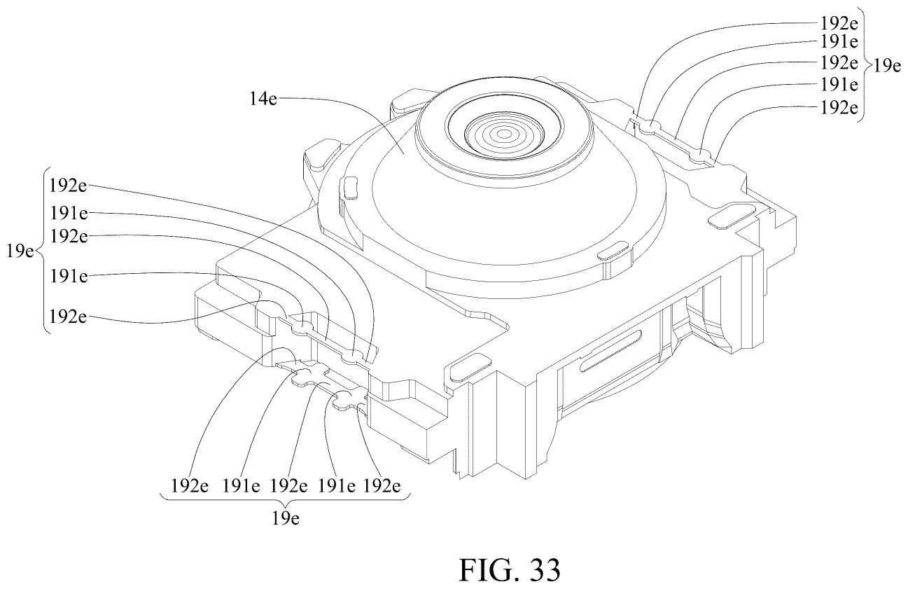

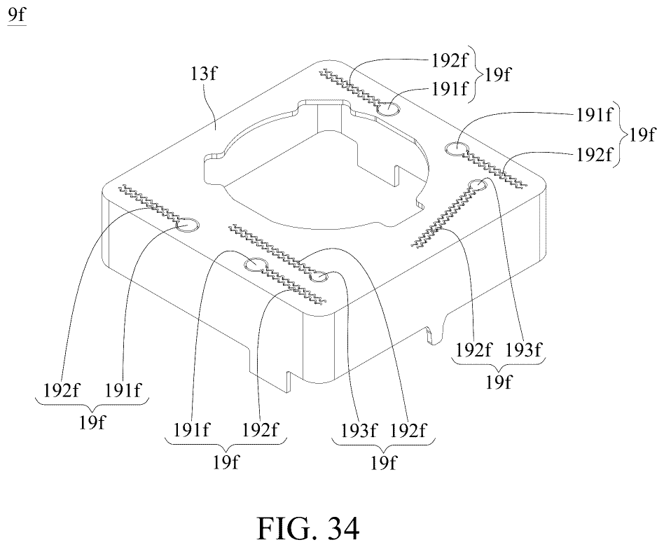

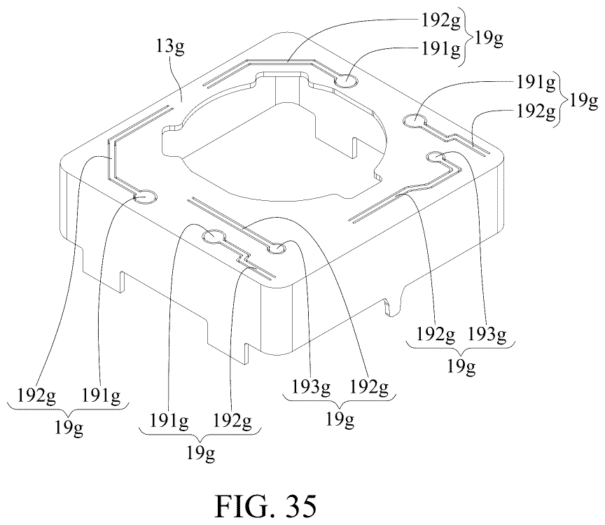

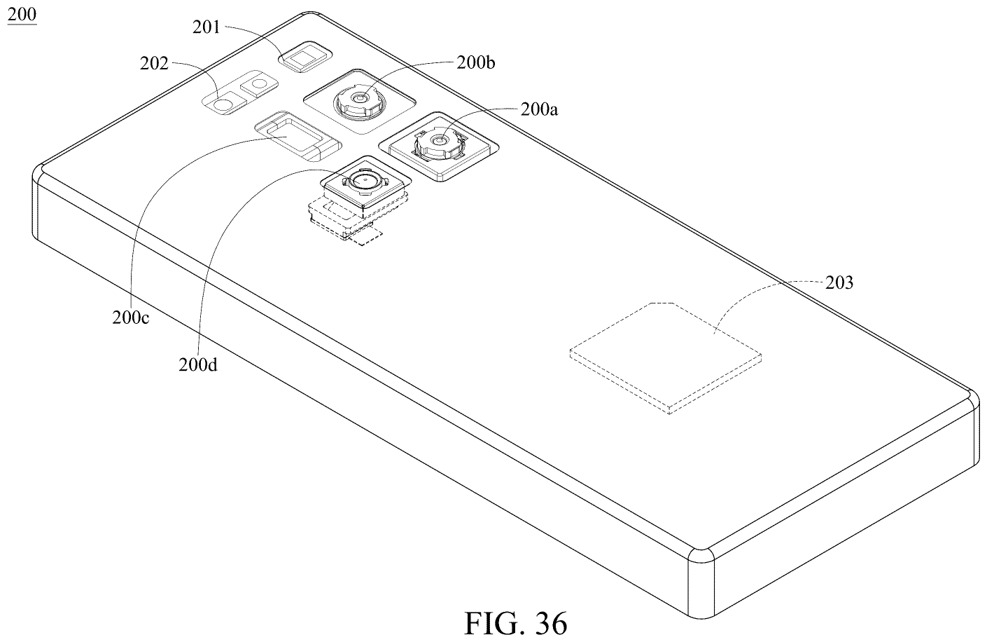

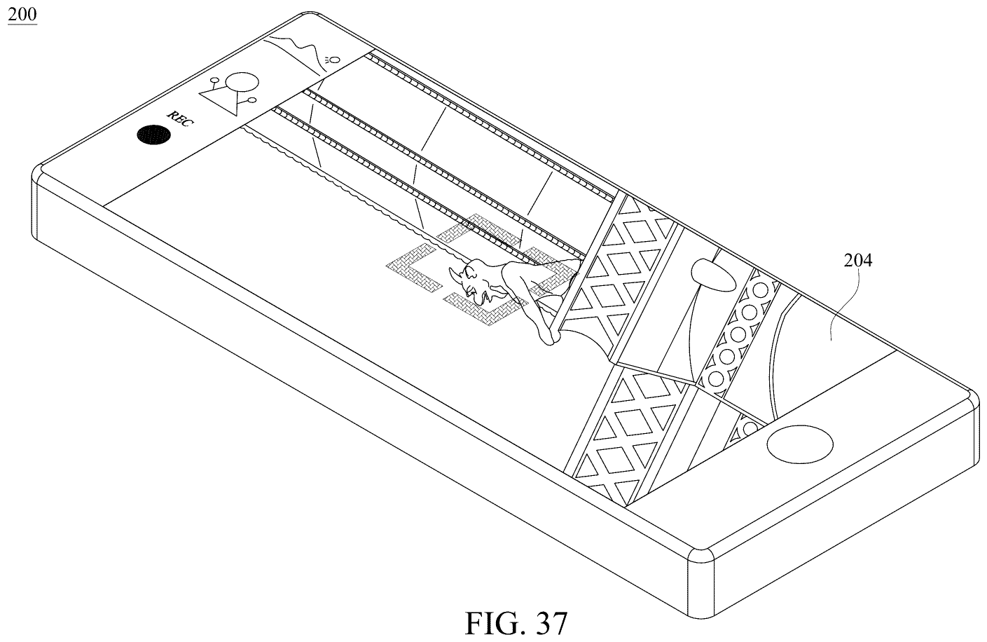

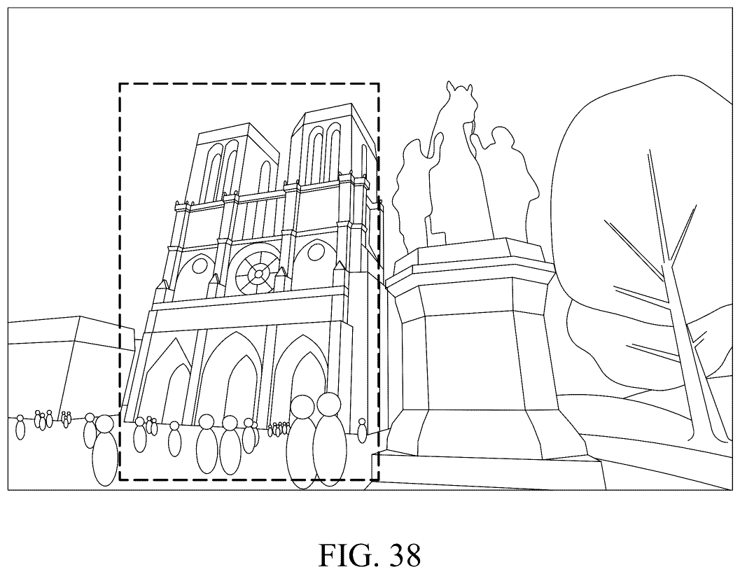

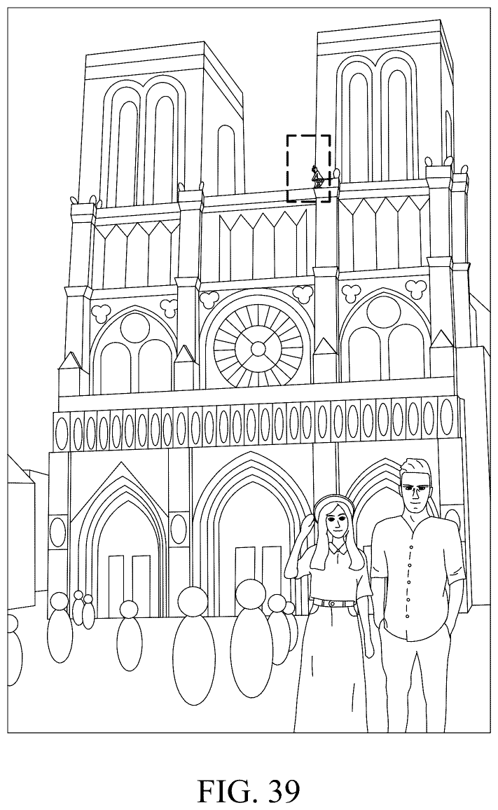

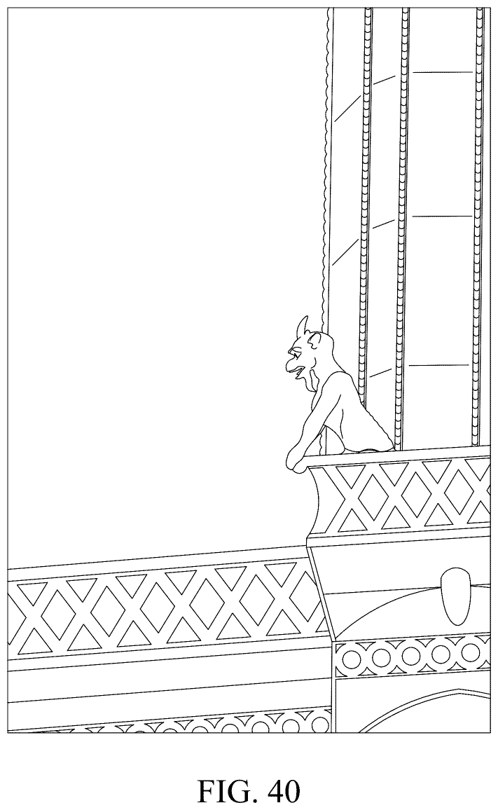

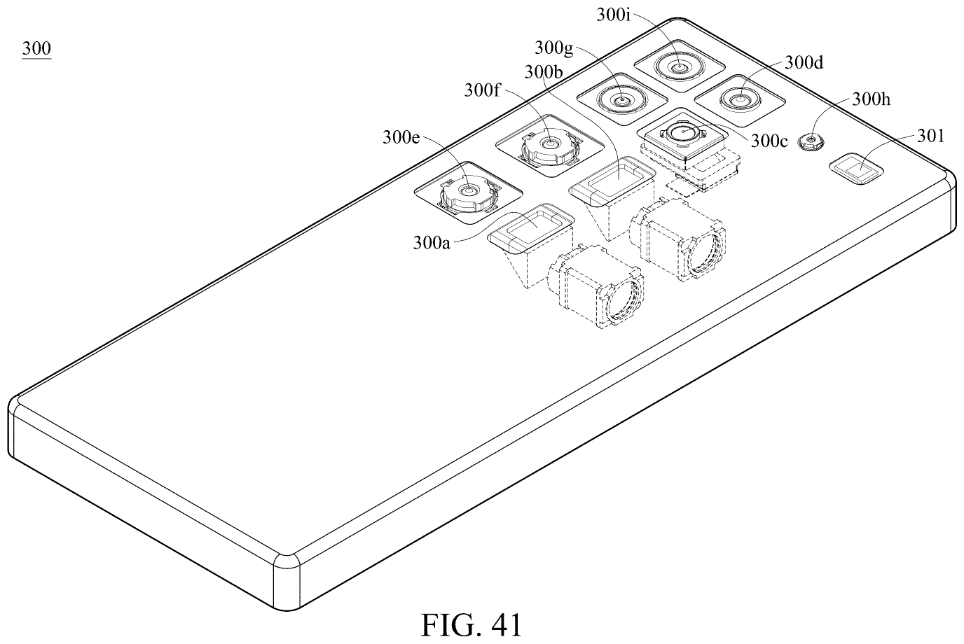

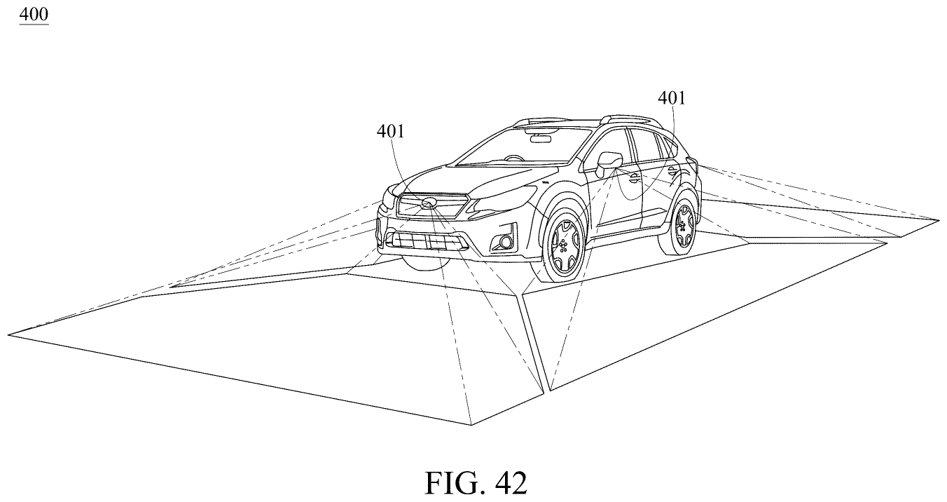

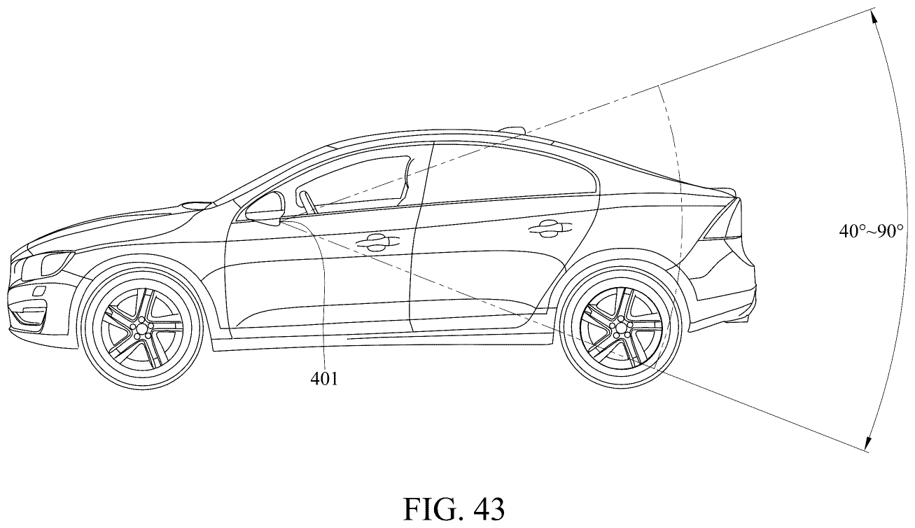

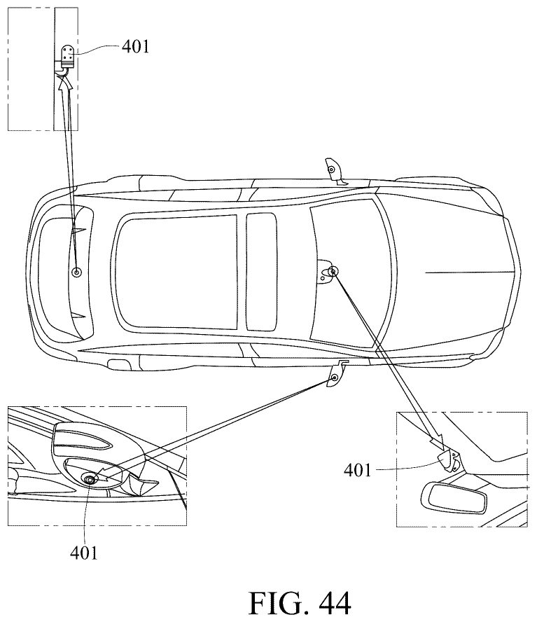

FIG. 1 is a perspective view of a camera module according to the 1st embodiment of the present disclosure, FIG. 2 is an exploded view of the camera module in FIG. 1, FIG. 3 is another exploded view of the camera module in FIG. 1, FIG. 4 is a perspective view of the camera module in FIG. 1 with a cover omitted, FIG. 5 is a top view of the camera module in FIG. 1, FIG. 6 is a top view of the camera module in FIG. 1 with the cover omitted, FIG. 7 is a front view of the camera module in FIG. 1 with the cover omitted, FIG. 8 is a cross-sectional view of the camera module taken along line 8-8 in FIG. 5, FIG. 9 is a cross-sectional view of the camera module taken along line 9-9 in FIG. 5, FIG. 10 is a perspective view of a base and flexure buffers of the camera module in FIG. 1, FIG. 11 is a cross-sectional view of the camera module taken along line 11-11 in FIG. 7, FIG. 12 is a rotated view of the camera module in FIG. 11, FIG. 13 is an enlarged view of regions EL1 and EL2 in FIG. 12, and FIG. 14 is a schematic view of the positional relationship between rails and balls in the camera module of FIG. 12.

A camera module 9 is provided in this embodiment, and the camera module 9 includes an imaging lens driving module 1 and an image sensor 8, and the image sensor 8 is disposed on an image surface IMG of the imaging lens driving module 1.

The imaging lens driving module 1 includes an imaging lens 11, a base 12, a cover 13, a lens carrier 14, a plurality of balls 15 and 16, a focus assembly 17, eight buffer counterparts 18 and four flexure buffers 19.

The imaging lens 11 includes two reduced portions R1, which are trimmed towards an optical axis OL of the imaging lens 11 respectively from opposite parts of the imaging lens 11, resulting in a non-circular shape of the imaging lens 11 in a direction surrounding the optical axis OL.

The cover 13 is coupled to the base 12, the cover 13 forms an internal space (its reference numeral is omitted) with the base 12, and the lens carrier 14 is disposed within the internal space. Moreover, the lens carrier 14 is movable in a direction parallel to the optical axis OL within the internal space.

The lens carrier 14 accommodates the imaging lens 11 and includes a first guide rail 141 and a second guide rail 142 extending in a direction parallel to the optical axis OL. Moreover, the first guide rail 141 has a first surface S1 and a second surface S2, and the first surface S1 and the second surface S2 are connected and form an included angle. The second guide rail 142 has a third surface S3 and a fourth surface S4, and the third surface S3 and the fourth surface S4 of the second guide rail 142 are connected and form an included angle.

The base 12 is disposed corresponding to the lens carrier 14, and the base 12 includes a third guide rail 123 and a fourth guide rail 124 extending in a direction parallel to the optical axis OL. Moreover, the third guide rail 123 has a fifth surface S5 and a sixth surface S6, and the fifth surface S5 and the sixth surface S6 are connected and form an included angle. The fourth guide rail 124 has a seventh surface S7 and an eighth surface S8, and the seventh surface S7 and the eighth surface S8 are connected and form an included angle.

As shown in FIG. 14, the fifth surface S5 of the third guide rail 123 and the seventh surface S7 of the fourth guide rail 124 are parallel to each other. Additionally, in this embodiment, the first surface S1 of the first guide rail 141 and the fifth surface S5 of the third guide rail 123 are parallel to each other, and the third surface S3 of the second guide rail 142 and the seventh surface S7 of the fourth guide rail 124 are parallel to each other.

When an angle between the fifth surface S5 of the third guide rail 123 and the seventh surface S7 of the fourth guide rail 124 is θ₅₇, and an angle between the sixth surface S6 of the third guide rail 123 and the eighth surface S8 of the fourth guide rail 124 is θ₆₈, the following conditions are satisfied: θ₅₇=180 degrees; θ₆₈=180 degrees; and |θ₅₇−π|=|θ₆₈−π|.

When an angle between the first surface S1 and the second surface S2 of the first guide rail 141 is θ₁₂, the following condition is satisfied: θ₁₂=90 degrees.

When an angle between the third surface S3 and the fourth surface S4 of the second guide rail 142 is θ₃₄, the following condition is satisfied: θ₃₄=90 degrees. When an angle between the fifth surface S5 and the sixth surface S6 of the third guide rail 123 is θ₅₆, the following condition is satisfied: θ₅₆=90 degrees.

When an angle between the seventh surface S7 and the eighth surface S8 of the fourth guide rail 124 is θ₇₈, the following condition is satisfied: θ₇₈=90 degrees.

The balls 15 and 16 are disposed between the lens carrier 14 and the base 12 to provide the lens carrier 14 with a degree of freedom for movement in a direction parallel to the optical axis OL. Moreover, the balls 15 and 16 include three first balls 15 and three second balls 16. The first balls 15 are disposed between the first guide rail 141 and the third guide rail 123, and the second balls 16 are disposed between the second guide rail 142 and the fourth guide rail 124.

The focus assembly 17 is configured to drive the lens carrier 14 to move in a direction parallel to the optical axis OL relative to the base 12 to achieve focusing of the imaging lens 11. Specifically, the focus assembly 17 includes a magnet 171 and a coil 172, and the coil 172 is disposed corresponding to the magnet 171. In this embodiment, the magnet 171 is coupled to the lens carrier 14 in a moving magnet drive configuration. Additionally, the coil 172 is disposed on the base 12, for example, through a circuit board 10 attached to the base 12.

The buffer counterparts 18 are disposed on the lens carrier 14 and are located on opposite sides of the lens carrier 14. Each of the buffer counterparts 18 includes a contact part D1.

As shown in FIG. 4, FIG. 6, FIG. 9 and FIG. 10, the flexure buffers 19 are disposed corresponding to the buffer counterparts 18, respectively. The flexure buffers 19 are all disposed on the base 12 and are respectively located on opposite sides of the lens carrier 14.

Each of the flexure buffers 19 includes a plurality of bumping parts 191 and a plurality of flexure parts 192. The bumping parts 191 are configured to physically contact the contact parts D1 of the buffer counterparts 18. The flexure parts 192 are recoverable and are connected to the bumping parts 191. The flexure parts 192 flex when the bumping parts 191 and the contact parts D1 bump into each other.

As shown in FIG. 4 and FIG. 6, among the flexure buffers 19, two of the flexure buffers 19 that are disposed on the base 12 and located closest to an object side each further include a stopper portion 193. When the lens carrier 14 is driven by the focus assembly 17 to move relative to the base 12, the stopper portions 193 are configured to physically contact the nearest one of the first balls 15 and the nearest one of the second balls 16, respectively so as to restrict the movement of the balls 15 and 16 within a certain range.

As shown in FIG. 7 and FIG. 9, when the lens carrier 14 is not driven by the focus assembly 17, the flexure buffers 19 and the buffer counterparts 18 are spaced apart from each other without physical contact therebetween.

As shown in FIG. 11 and FIG. 12, the first balls 15 include a first ball center B1, and the second balls 16 include a second ball center B2. The first ball center B1 and the second ball center B2 are connected to form a first connection line L1 on a plane perpendicular to the optical axis OL. Moreover, the first connection line L1 has a first midpoint P1.

The optical axis OL and the first connection line L1 are connected to form a second connection line L2 on a plane perpendicular to the optical axis OL. The second connection line L2 is orthogonal to and intersects both the optical axis OL and the first connection line L1. Additionally, an intersection point of the first connection line L1 and the second connection line L2 is an eccentric point P2. In this embodiment, the eccentric point P2 does not coincide with the first midpoint P1.

As shown in FIG. 14, the fifth surface S5 of the third guide rail 123 is located closer to the first midpoint P1 than the sixth surface S6, and the seventh surface S7 of the fourth guide rail 124 is located closer to the first midpoint P1 than the eighth surface S8.

In this embodiment, the first surface S1, the second surface S2, the fifth surface S5 and the sixth surface S6 each have a contact point C1 with each of the first balls 15. Additionally, the third surface S3, the fourth surface S4, the seventh surface S7 and the eighth surface S8 each have a contact point C1 with each of the second balls 16.

As shown in FIG. 11 and FIG. 12, in the 1st embodiment, the eccentric point P2 does not coincide with the first midpoint P1 of the first connection line L1, but the present disclosure is not limited thereto. For example, please refer to FIG. 15, which is a cross-sectional view of the positional relationship between the balls, a lens carrier and a base of the camera module according to an exemplary configuration of the present disclosure. A base 12a1, a lens carrier 14a1, first balls 15a1 and second balls 16a1 shown in FIG. 15 are similar to the base 12, the lens carrier 14, the first balls 15 and the second balls 16 shown in FIG. 1 to FIG. 14, respectively, and similar or identical reference numerals are used to denote similar or identical components. The functions and effects of these components are the same as previously described, so an explanation in this regard will not be provided again.

In the exemplary configuration shown in FIG. 15, an eccentric point P2 coincides with a first midpoint P1. Specifically, a first ball center B1 and a second ball center B2 are connected to form a first connection line L1 on a plane perpendicular to an optical axis OL, and the first connection line L1 has a first midpoint P1. Additionally, the optical axis OL and the first connection line L1 are connected to form a second connection line L2 on a plane perpendicular to the optical axis OL, and the second connection line L2 is orthogonal to and intersects both the optical axis OL and the first connection line L1. An intersection point of the first connection line L1 and the second connection line L2 is the eccentric point P2, and the eccentric point P2 coincides with the first midpoint P1.

As shown in FIG. 12 to FIG. 14, in the 1st embodiment, each of the first balls 15 has a contact point C1 with the first surface S1, and each of the second balls 16 has a contact point C1 with the third surface S3. Additionally, the angle θ₅₇ between the fifth surface S5 of the third guide rail 123 and the seventh surface S7 of the fourth guide rail 124 is 180 degrees, the angle θ₆₈ between the sixth surface S6 of the third guide rail 123 and the eighth surface S8 of the fourth guide rail 124 is also 180 degrees, and the following condition is satisfied: |θ₅₇−π|=|θ₆₈−π|. However, the present disclosure is not limited thereto. For example, please refer to FIG. 16 and FIG. 17, wherein FIG. 16 is a cross-sectional view of the positional relationship between the balls, a lens carrier and a base of the camera module according to an exemplary configuration of the present disclosure, and FIG. 17 is an enlarged view of regions EL3 and EL4 in FIG. 16. A base 12a2, a lens carrier 14a2, first balls 15a2 and second balls 16a2 shown in FIG. 16 and FIG. 17 are similar to the base 12, the lens carrier 14, the first balls 15 and the second balls 16 shown in FIG. 1 to FIG. 14, and similar or identical reference numerals are used to denote similar or identical components. The functions and effects of these components are the same as previously described, so an explanation in this regard will not be provided again.

In the exemplary configuration shown in FIG. 16 and FIG. 17, there is a gap G1 between each of the first balls 15a2 and a first surface S1 of a first guide rail 141a2, and there is a gap G1 between each of the second balls 16a2 and a third surface S3 of a second guide rail 142a2. In other words, each of the first balls 15a2 does not physically contact the first surface S1, and each of the second balls 16a2 does not physically contact the third surface S3. It should be noted that, in this exemplary configuration, a second surface S2, a fifth surface S5 and a sixth surface S6 each have a contact point C1 with each of the first balls 15a2, and a fourth surface S4, a seventh surface S7 and an eighth surface S8 each have a contact point C1 with each of the second balls 16a2.

Additionally, in the exemplary configuration shown in FIG. 16 and FIG. 17, when an angle between the fifth surface S5 of the third guide rail 123a2 and the seventh surface S7 of the fourth guide rail 124a2 is θ₅₇, and an angle between the sixth surface S6 of the third guide rail 123a2 and the eighth surface S8 of the fourth guide rail 124a2 is θ₆₈, the following conditions are satisfied: θ₅₇=180 degrees; θ₆₈=39 degrees; and |θ₅₇−π|<|θ₆₈−π|.

### 2nd Embodiment

FIG. 18 is an exploded view of some components of a camera module according to the 2nd embodiment of the present disclosure, FIG. 19 is another exploded view of the camera module in FIG. 18, FIG. 20 is a front view of some components of the camera module according to the 2nd embodiment of the present disclosure, and FIG. 21 is a perspective view of the positional relationship between an imaging lens, a lens carrier and flexure buffers in the camera module of FIG. 19.

A camera module 9b in the 2nd embodiment is similar to the camera module 9 in the 1st embodiment, and similar or identical reference numerals are used to denote similar or identical components. The functions and effects of these components are the same as previously described, so an explanation in this regard will not be provided again.

In the 2nd embodiment, eight buffer counterparts 18b are located on opposite sides of a lens carrier 14b. As shown in FIG. 18 and FIG. 19, among the eight buffer counterparts 18b, four of the buffer counterparts 18b located between the lens carrier 14b and a cover (not shown in FIG. 18 and FIG. 19) are disposed on the lens carrier 14b, and the other four of the buffer counterparts 18b located between the lens carrier 14b and a base 12b are disposed on the base 12b.

Four flexure buffers 19b are disposed corresponding to the buffer counterparts 18b. In the 2nd embodiment, as shown in FIG. 20 and FIG. 21, among the four flexure buffers 19b, two of the flexure buffers 19b are disposed on the base 12b, and the other two of the flexure buffers 19b are disposed on the lens carrier 14b.

Each of the flexure buffers 19b includes a plurality of bumping parts 191b and a plurality of flexure parts 192b. The bumping parts 191b are configured to physically contact the contact parts D1 of the buffer counterparts 18b, respectively. The flexure parts 192b are recoverable and are connected to the bumping parts 191b, and the flexure parts 192b flex when the bumping parts 191b and the contact parts D1 bump into each other.

As shown in FIG. 20, when the lens carrier 14b is driven by a focus assembly (not shown in FIG. 20), the flexure buffers 19b and the buffer counterparts 18b are spaced apart from each other without physical contact therebetween.

### 3rd Embodiment

FIG. 22 is an exploded view of some components of a camera module according to the 3rd embodiment of the present disclosure, FIG. 23 is another exploded view of the camera module in FIG. 22, FIG. 24 is a front view of some components of the camera module according to the 3rd embodiment of the present disclosure, and FIG. 25 is a perspective view of the positional relationship between an imaging lens, a lens carrier and flexure buffers in the camera module of FIG. 23.

A camera module 9c in the 3rd embodiment is similar to the camera module 9 in the 1st embodiment, and similar or identical reference numerals are used to denote similar or identical components. The functions and effects of these components are the same as previously described, so an explanation in this regard will not be provided again.

In the 3rd embodiment, eight buffer counterparts 18c are located on opposite sides of a lens carrier 14c. As shown in FIG. 22 and FIG. 23, among the eight buffer counterparts 18c, four of the buffer counterparts 18c located between the lens carrier 14c and a cover (not shown in FIG. 22 and FIG. 23) are disposed on the lens carrier 14c, and the other four of the buffer counterparts 18c located between the lens carrier 14c and a base 12c are disposed on the base 12c.

Four flexure buffers 19c are disposed corresponding to the buffer counterparts 18c. In the 3rd embodiment, as shown in FIG. 24 and FIG. 25, among the four flexure buffers 19c, two of the flexure buffers 19c are disposed on the base 12c, and the other two of the flexure buffers 19c are disposed on the lens carrier 14c. Moreover, the lens carrier 14c and the two of the flexure buffers 19c corresponding to the four of the buffer counterparts 18c on the base 12c are integrally formed.

Each of the flexure buffers 19c includes a plurality of bumping parts 191c and a plurality of flexure parts 192c. The bumping parts 191c are configured to physically contact the contact parts D1 of the buffer counterparts 18c, respectively. The flexure parts 192c are recoverable and are connected to the bumping parts 191c, and the flexure parts 192c flex when the bumping parts 191c and the contact parts D1 bump into each other.

As shown in FIG. 24, when the lens carrier 14c is driven by a focus assembly (not shown in FIG. 24), the flexure buffers 19c and the buffer counterparts 18c are spaced apart from each other without physical contact therebetween.

### 4th Embodiment

FIG. 26 is an exploded view of some components of a camera module according to the 4th embodiment of the present disclosure, FIG. 27 is another exploded view of the camera module in FIG. 26, FIG. 28 is a front view of some components of the camera module according to the 4th embodiment of the present disclosure, and FIG. 29 is a perspective view of the positional relationship between an imaging lens, a lens carrier and flexure buffers in the camera module of FIG. 27.

A camera module 9d in the 4th embodiment is similar to the camera module 9 in the 1st embodiment, and similar or identical reference numerals are used to denote similar or identical components. The functions and effects of these components are the same as previously described, so an explanation in this regard will not be provided again.

In the 4th embodiment, buffer counterparts 18d are all disposed on a lens carrier 14d and are located on opposite sides of the lens carrier 14d.

Flexure buffers 19d are disposed corresponding to the buffer counterparts 18d. In the 4th embodiment, as shown in FIG. 28 and FIG. 29, the flexure buffers 19d are all disposed on a base 12d and are located on opposite sides of the lens carrier 14d. Moreover, the base 12d and two of the flexure buffers 19d that are disposed on the base 12d and located closest to an image side are integrally formed.

Each of the flexure buffers 19d includes a plurality of bumping parts 191d and a plurality of flexure parts 192d. The bumping parts 191d are configured to physically contact the contact parts D1 of the buffer counterparts 18d, respectively. The flexure parts 192d are recoverable and are connected to the bumping parts 191d, and the flexure parts 192d flex when the bumping parts 191d and the contact parts D1 bump into each other.

As shown in FIG. 28, when the lens carrier 14d is not driven by a focus assembly (not shown in FIG. 28), the flexure buffers 19d and the buffer counterparts 18d are spaced apart from each other without physical contact therebetween.

### 5th Embodiment

FIG. 30 is an exploded view of some components of a camera module according to the 5th embodiment of the present disclosure, FIG. 31 is another exploded view of the camera module in FIG. 30, FIG. 32 is a cross-sectional view of some components of the camera module according to the 5th embodiment of the present disclosure, and FIG. 33 is a perspective view of the positional relationship between an imaging lens, a lens carrier and flexure buffers in the camera module of FIG. 30.

A camera module 9e in the 5th embodiment is similar to the camera module 9 in the 1st embodiment, and similar or identical reference numerals are used to denote similar or identical components. The functions and effects of these components are the same as previously described, so an explanation in this regard will not be provided again.

In the 5th embodiment, buffer counterparts 18e are located on opposite sides of a lens carrier 14e. As shown in FIG. 30 and FIG. 31, among the buffer counterparts 18e, some of the buffer counterparts 18e located between the lens carrier 14e and a cover 13e are disposed on and integrally formed with the cover 13e, and the other of the buffer counterparts 18e located between the lens carrier 14e and a base 12e are disposed on and integrally formed with the base 12e.

Four flexure buffers 19e are disposed corresponding to the buffer counterparts 18e. In the 5th embodiment, as shown in FIG. 32 and FIG. 33, the four flexure buffers 19e are all disposed on the lens carrier 14e, and the four flexure buffers 19e and the lens carrier 14e are integrally formed.

Each of the flexure buffers 19e includes a plurality of bumping parts 191e and a plurality of flexure parts 192e. The bumping parts 191e are configured to physically contact the contact parts D1 of the buffer counterparts 18e, respectively. The flexure parts 192e are recoverable and are connected to the bumping parts 191e, and the flexure parts 192e flex when the bumping parts 191e and the contact parts D1 bump into each other. In the 5th embodiment, stopper portions for physically contacting the balls may not be included by the flexure buffers 19e.

As shown in FIG. 32, when the lens carrier 14e is not driven by a focus assembly (not shown in FIG. 32), the flexure buffers 19e and the buffer counterparts 18e are spaced apart from each other without physical contact therebetween.

### 6th Embodiment

FIG. 34 is a perspective view of a cover and flexure buffers in a camera module according to the 6th embodiment of the present disclosure.

A camera module 9f in the 6th embodiment is similar to the camera module 9 in the 1st embodiment, and similar or identical reference numerals are used to denote similar or identical components. The functions and effects of these components are the same as previously described, so an explanation in this regard will not be provided again.

In the 6th embodiment, a cover 13f is further provided with a plurality of flexure buffers 19f, and the flexure buffers 19f disposed on the cover 13f are arranged corresponding to a plurality of buffer counterparts (not shown) disposed on a lens carrier (not shown) or corresponding to balls (not shown). Moreover, the flexure buffers 19f disposed on the cover 13f are integrally formed with the cover 13f.

Among the flexure buffers 19f, four of the flexure buffers 19f arranged corresponding to the buffer counterparts each include a bumping part 191f and a flexure part 192f. The bumping parts 191f are configured to physically contact the contact parts of the buffer counterparts, respectively. The flexure parts 192f are recoverable, and opposite ends of each of the flexure parts 192f are connected to the bumping parts 191f and the cover 13f, respectively. The flexure parts 192f flex when the bumping parts 191f and the contact parts bump into each other.

Among the flexure buffers 19f, two of the flexure buffers 19f arranged corresponding to the balls each include a stopper portion 193f and a flexure part 192f. When the lens carrier is driven by a focus assembly (not shown) to move relative to a base (not shown), the stopper portions 193f are configured to physically contact the balls to restrict the movement of the balls within a certain range. The flexure parts 192f are recoverable, and opposite ends of the flexure parts 192f are connected to the stopper portions 193f and the cover 13f, respectively. The flexure parts 192f are configured to flex when the stopper portions 193f physically contact the balls.

It should be noted that the present disclosure is not limited to the number of flexure buffers shown in FIG. 34.

In the 6th embodiment, each of the flexure parts 192f of the flexure buffers 19f disposed on the cover 13f is in a zigzag shape, but the present disclosure is not limited thereto. For example, please refer to FIG. 35, which is a perspective view of a cover and flexure buffers in a camera module according to an exemplary embodiment of the present disclosure. A cover 13g and flexure buffers 19g shown in FIG. 35 are similar to the cover 13f and the flexure buffers 19f shown in FIG. 34, and similar or identical reference numerals are used to denote similar or identical components. The functions and effects of these components are the same as previously described, so an explanation in this regard will not be provided again.

In the exemplary configuration shown in FIG. 35, among the flexure buffers 19g, four of the flexure buffers 19g arranged corresponding to buffer counterparts each include a bumping part 191g and a flexure part 192g, and the other two of the flexure buffers 19g arranged corresponding to balls each include a stopper portion 193g and a flexure part 192g. Moreover, the flexure parts 192g of the flexure buffers 19g disposed on the cover 13g can be straight or can have one or more bent sections to form a polyline shape.

### 7th Embodiment

Please refer to FIG. 36 and FIG. 37. FIG. 36 is a perspective view of an electronic device according to the 7th embodiment of the present disclosure, and FIG. 37 is another perspective view of the electronic device in FIG. 36.

In this embodiment, the electronic device 200 is a smartphone including a plurality of camera modules, a flash module 201, a focus assist module 202, an image signal processor 203, a display module (user interface) 204 and an image software processor (not shown).

These camera modules include an ultra-wide-angle camera module 200a, a high pixel camera module 200b, a telephoto camera module 200c and a telephoto camera module 200d. Moreover, the camera module 200d includes, for example, the imaging lens driving module 1 as disclosed in the 1st embodiment of the present disclosure, but the present disclosure is not limited thereto. At least one of the camera modules 200a, 200b, and 200c can include the imaging lens driving module of the present disclosure.

The image captured by the ultra-wide-angle camera module 200a enjoys a feature of multiple imaged objects. FIG. 38 is an image captured by the ultra-wide-angle camera module 200a.

The image captured by the high pixel camera module 200b enjoys a feature of high resolution and less distortion, and the high pixel camera module 200b can capture part of the image in FIG. 38. FIG. 39 is an image captured by the high pixel camera module 200b.

The image captured by the telephoto camera module 200c or the telephoto camera module 200d enjoys a feature of high optical magnification, and the telephoto camera module 200c or the telephoto camera module 200d can capture part of the image in FIG. 39. FIG. 40 is an image captured by the telephoto camera module 200c or the telephoto camera module 200d.

When a user captures images of an object, the light rays converge in the ultra-wide-angle camera module 200a, the high pixel camera module 200b, the telephoto camera module 200c or the telephoto camera module 200d to generate images, and the flash module 201 is activated for light supplement. The focus assist module 202 detects the object distance of the imaged object to achieve fast auto focusing. The image signal processor 203 is configured to optimize the captured image to improve image quality and provided zooming function. The light beam emitted from the focus assist module 202 can be either conventional infrared or laser. The display module 204 can include a touch screen, and the user is able to interact with the display module 204 to adjust the angle of view and switch between different camera modules, and the image software processor having multiple functions to capture images and complete image processing. Alternatively, the user may capture images via a physical button. The image processed by the image software processor can be displayed on the display module 204.

### 8th Embodiment

Please refer to FIG. 41, which is a perspective view of an electronic device according to the 8th embodiment of the present disclosure.

In this embodiment, the electronic device 300 is a smartphone including a camera module 300a, a camera module 300b, a camera module 300c, a camera module 300d, a camera module 300e, a camera module 300f, a camera module 300g, a camera module 300h, a camera module 300i, a flash module 301, an image signal processor, a display module and an image software processor (not shown). The camera module 300a, the camera module 300b, the camera module 300c, the camera module 300d, the camera module 300e, the camera module 300f, the camera module 300g, the camera module 300h and the camera module 300i are disposed on the same side of the electronic device 300, while the display module is disposed on the opposite side of the electronic device 300. Moreover, the camera module 300c includes, for example, the imaging lens driving module 1 as disclosed in the 1st embodiment of the present disclosure, but the present disclosure is not limited thereto. At least one of the camera modules 300a, 300b, 300d, 300e, 300f, 300g, 300h, and 300i can include the imaging lens driving module of the present disclosure.

The camera module 300a is a telephoto camera module, the camera module 300b is a telephoto camera module, the camera module 300c is a telephoto camera module, the camera module 300d is a telephoto camera module, the camera module 300e is a wide-angle camera module, the camera module 300f is a wide-angle camera module, the camera module 300g is a ultra-wide-angle camera module, the camera module 300h is a ToF (time of flight) camera module, and the camera module 300i is an ultra-wide-angle camera module. In this embodiment, the camera module 300i, the camera module 300a, the camera module 300b, the camera module 300c, the camera module 300d, the camera module 300e, the camera module 300f and the camera module 300g have different fields of view, such that the electronic device 300 can have various magnification ratios so as to meet the requirement of optical zoom functionality. In addition, the camera module 300a and camera module 300b are telephoto camera modules having a light-folding element configuration. In addition, the camera module 300h can determine depth information of the imaged object. In this embodiment, the electronic device 300 includes multiple camera modules 300a, 300b, 300c, 300d, 300e, 300f, 300g, 300h, and 300i, but the present disclosure is not limited to the number and arrangement of camera modules. When a user captures images of an object, the light rays converge in the camera module 300a, the camera module 300b, the camera module 300c, the camera module 300d, the camera module 300e, the camera module 300f, the camera module 300g, the camera module 300h or the camera module 300i to generate an image(s), and the flash module 301 is activated for light supplement. Further, the subsequent processes are performed in a manner similar to the abovementioned embodiments, so the details in this regard will not be provided again.

### 9th Embodiment

Please refer to FIG. 42 to FIG. 44. FIG. 42 is a perspective view of an electronic device according to the 9th embodiment of the present disclosure, FIG. 43 is a side view of the electronic device in FIG. 42, and FIG. 44 is a top view of the electronic device in FIG. 42.

In this embodiment, the electronic device 400 is an automobile. The electronic device 400 includes a plurality of automotive camera module 401, and the camera modules 401 each include the imaging lens driving module of the present disclosure. The camera modules 401 can serve as, for example, panoramic view car cameras, dashboard cameras and vehicle backup cameras.

As shown in FIG. 42, the camera modules 401 are, for example, disposed around the automobile to capture peripheral images of the automobile, which is favorable for obtaining external traffic information so as to achieve autopilot function. In addition, the image software processor may stitch the peripheral images into one panoramic view image for the driver's checking every corner surrounding the automobile, thereby favorable for parking and driving.

As shown in FIG. 43, the camera modules 401 are, for example, respectively disposed on the lower portion of the side mirrors. A maximum field of view of the camera modules 401 can be 40 degrees to 90 degrees for capturing images in regions on left and right lanes.

As shown in FIG. 44, the camera modules 401 can also be, for example, respectively disposed on the lower portion of the side mirrors and inside the front and rear windshields for providing external information to the driver, and also providing more viewing angles so as to reduce blind spots, thereby improving driving safety.

The smartphones, panoramic view car cameras, dashboard cameras and vehicle backup cameras in the embodiments are only exemplary for showing the imaging lens driving module of the present disclosure installed in an electronic device, and the present disclosure is not limited thereto. The imaging lens driving module can be optionally applied to optical systems with a movable focus. Furthermore, the imaging lens driving module features good capability in aberration corrections and high image quality, and can be applied to 3D (three-dimensional) image capturing applications, in products such as digital cameras, mobile devices, digital tablets, smart televisions, network surveillance devices, multi-camera devices, image recognition systems, motion sensing input devices, wearable devices and other electronic imaging devices.

The foregoing description, for the purpose of explanation, has been described with reference to specific embodiments. It is to be noted that the present disclosure shows different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens driving module comprising:
an imaging lens having an optical axis;
a lens carrier accommodating the imaging lens, and the lens carrier comprising:
a first guide rail extending in a direction parallel to the optical axis, and the first guide rail having a second surface; and
a second guide rail extending in a direction parallel to the optical axis, and the second guide rail having a fourth surface;
a base disposed corresponding to the lens carrier, and the base comprising:
a third guide rail extending in a direction parallel to the optical axis, the third guide rail having a fifth surface and a sixth surface, and the fifth surface and the sixth surface are connected and form an included angle; and
a fourth guide rail extending in a direction parallel to the optical axis, the fourth guide rail having a seventh surface and an eighth surface, and the seventh surface and the eighth surface are connected and form an included angle;
a plurality of balls disposed between the lens carrier and the base, the plurality of balls configured to provide the lens carrier with a degree of freedom for movement along a direction parallel to the optical axis, and the plurality of balls comprising:
at least one first ball disposed between the first guide rail and the third guide rail; and
at least one second ball disposed between the second guide rail and the fourth guide rail;
a focus assembly configured to drive the lens carrier to move in a direction parallel to the optical axis relative to the base so as to achieve focusing of the imaging lens;
at least one buffer counterpart; and
at least one flexure buffer disposed corresponding to the at least one buffer counterpart, and the at least one flexure buffer being disposed on at least one of the lens carrier and the base, wherein the at least one flexure buffer is flexible to mitigate an impact of bumping between the at least one flexure buffer and the at least one buffer counterpart through its flexure when the lens carrier moves in a direction parallel to the optical axis;
wherein the at least one first ball comprises a first center, the at least one second ball comprises a second center, the first center and the second center are connected to form a first connection line on a plane perpendicular to the optical axis, and the first connection line has a first midpoint;
when the lens carrier is driven by the focus assembly to move relative to the base, a stopper portion of the at least one flexure buffer is configured to physically contact the plurality of balls to restrict movement of the plurality of balls within a certain range;
when the lens carrier is not driven by the focus assembly, the at least one flexure buffer and the at least one buffer counterpart are spaced apart from each other without physical contact therebetween;
wherein the fifth surface is located closer to the first midpoint than the sixth surface, the seventh surface is located closer to the first midpoint than the eighth surface, the second surface, the fifth surface and the sixth surface each have a contact point with the at least one first ball, and the fourth surface, the seventh surface and the eighth surface each have a contact point with the at least one second ball;
wherein an angle between the fifth surface and the seventh surface is θ₅₇, an angle between the sixth surface and the eighth surface is θ₆₈, and the following condition is satisfied:

|θ₅₇−π|≤|θ₆₈−π|; and
wherein the fifth surface and the seventh surface are parallel to each other.

2. The imaging lens driving module of claim 1, further comprising:
a cover coupled to the base and forming an internal space with the base, and the lens carrier is disposed within the internal space.

3. The imaging lens driving module of claim 1, wherein the at least one flexure buffer further comprises:
a bumping part configured to physically contact a contact part of the at least one buffer counterpart; and
a flexure part connected to the bumping part, wherein the flexure part flexes when the bumping part and the contact part bump into each other.

4. The imaging lens driving module of claim 2, wherein the at least one flexure buffer is further disposed on the cover.

5. The imaging lens driving module of claim 1, wherein the at least one buffer counterpart is disposed on the base.

6. The imaging lens driving module of claim 1, wherein the at least one buffer counterpart is disposed on the lens carrier.

7. The imaging lens driving module of claim 2, wherein the at least one buffer counterpart is disposed on the cover.

8. The imaging lens driving module of claim 1, wherein the focus assembly comprises:
a magnet; and
a coil disposed corresponding to the magnet, wherein one of the magnet and the coil is coupled to the lens carrier.

9. The imaging lens driving module of claim 1, wherein the at least one first ball comprises at least two first balls, and the at least one second ball comprises at least two second balls.

10. The imaging lens driving module of claim 1, wherein the optical axis and the first connection line are connected to form a second connection line on a plane perpendicular to the optical axis, the second connection line is orthogonal to and intersects both the optical axis and the first connection line, and an intersection point of the first connection line and the second connection line is an eccentric point.

11. The imaging lens driving module of claim 10, wherein the eccentric point does not coincide with the first midpoint.

12. The imaging lens driving module of claim 10, wherein the eccentric point coincides with the first midpoint.

13. The imaging lens driving module of claim 1, wherein the first guide rail further has a first surface, the first surface and the second surface are connected and form an included angle, the second guide rail further has a third surface, and the third surface and the fourth surface are connected and form an included angle;
wherein the first surface and the fifth surface are parallel to each other, and the third surface and the seventh surface are parallel to each other; and
wherein a gap is provided between the first surface and the at least one first ball and/or between the third surface and the at least one second ball.

14. The imaging lens driving module of claim 1, wherein an angle between the fifth surface and the sixth surface is θ₅₆, an angle between the seventh surface and the eighth surface is θ₇₈, and the following conditions are satisfied:
$$\begin{matrix}π / 2 \leq {θ}_{56} < π ; and \\ π / 2 \leq {θ}_{78} < π .\end{matrix}$$

15. The imaging lens driving module of claim 14, wherein the angle between the fifth surface and the sixth surface is θ₅₆, the angle between the seventh surface and the eighth surface is θ₇₈, and the following conditions are satisfied:
$$\begin{matrix}98 degrees \leq {θ}_{56} < π ; and \\ 98 degrees \leq {θ}_{78} < π .\end{matrix}$$

16. The imaging lens driving module of claim 1, wherein the imaging lens comprises:
a reduced portion trimmed towards the optical axis from a part of the imaging lens, resulting in a non-circular shape of the imaging lens in a direction surrounding the optical axis.

17. A camera module comprising:
the imaging lens driving module of claim 1; and
an image sensor disposed on an image surface of the imaging lens driving module.

18. An electronic device comprising:
the camera module of claim 17.

19. An imaging lens driving module comprising:
an imaging lens having an optical axis;
a lens carrier accommodating the imaging lens, and the lens carrier comprising:
a first guide rail extending in a direction parallel to the optical axis, and the first guide rail having a second surface; and
a second guide rail extending in a direction parallel to the optical axis, and the second guide rail having a fourth surface;
a base disposed corresponding to the lens carrier, and the base comprising:
a third guide rail extending in a direction parallel to the optical axis, the third guide rail having a fifth surface and a sixth surface, and the fifth surface and the sixth surface are connected and form an included angle; and
a fourth guide rail extending in a direction parallel to the optical axis, the fourth guide rail having a seventh surface and an eighth surface, and the seventh surface and the eighth surface are connected and form an included angle;
a plurality of balls disposed between the lens carrier and the base, the plurality of balls configured to provide the lens carrier with a degree of freedom for movement along a direction parallel to the optical axis, and the plurality of balls comprising:
at least one first ball disposed between the first guide rail and the third guide rail; and
at least one second ball disposed between the second guide rail and the fourth guide rail;
a focus assembly configured to drive the lens carrier to move in a direction parallel to the optical axis relative to the base so as to achieve focusing of the imaging lens;
at least one buffer counterpart; and
at least one flexure buffer disposed corresponding to the at least one buffer counterpart, and the at least one flexure buffer being disposed on at least one of the lens carrier and the base, wherein the at least one flexure buffer is flexible to mitigate an impact of bumping between the at least one flexure buffer and the at least one buffer counterpart through its flexure when the lens carrier moves in a direction parallel to the optical axis;
wherein the at least one first ball comprises a first center, the at least one second ball comprises a second center, the first center and the second center are connected to form a first connection line on a plane perpendicular to the optical axis, and the first connection line has a first midpoint;
when the lens carrier is not driven by the focus assembly, the at least one flexure buffer and the at least one buffer counterpart are spaced apart from each other without physical contact therebetween;
wherein the fifth surface is located closer to the first midpoint than the sixth surface, the seventh surface is located closer to the first midpoint than the eighth surface, the second surface, the fifth surface and the sixth surface each have a contact point with the at least one first ball, and the fourth surface, the seventh surface and the eighth surface each have a contact point with the at least one second ball; and
wherein an angle between the fifth surface and the seventh surface is θ₅₇, an angle between the sixth surface and the eighth surface is θ₆₈, and the following condition is satisfied:
$$\vert {θ}_{57 - π} \vert \leq \vert {θ}_{68 - π} \vert .$$

20. The imaging lens driving module of claim 19, further comprising:
a cover coupled to the base and forming an internal space with the base, and the lens carrier is disposed within the internal space.

21. The imaging lens driving module of claim 19, wherein the at least one flexure buffer comprises:
a bumping part configured to physically contact a contact part of the at least one buffer counterpart; and
a flexure part connected to the bumping part, wherein the flexure part flexes when the bumping part and the contact part bump into each other.

22. The imaging lens driving module of claim 20, wherein the at least one flexure buffer is further disposed on the cover.

23. The imaging lens driving module of claim 19, wherein the at least one buffer counterpart is disposed on the base.

24. The imaging lens driving module of claim 19, wherein the at least one buffer counterpart is disposed on the lens carrier.

25. The imaging lens driving module of claim 20, wherein the at least one buffer counterpart is disposed on the cover.

26. The imaging lens driving module of claim 19, wherein the focus assembly comprises:
a magnet; and
a coil disposed corresponding to the magnet, wherein one of the magnet and the coil is coupled to the lens carrier.

27. The imaging lens driving module of claim 19, wherein the at least one first ball comprises at least two first balls, and the at least one second ball comprises at least two second balls.

28. The imaging lens driving module of claim 19, wherein the optical axis and the first connection line are connected to form a second connection line on a plane perpendicular to the optical axis, the second connection line is orthogonal to and intersects both the optical axis and the first connection line, and an intersection point of the first connection line and the second connection line is an eccentric point.

29. The imaging lens driving module of claim 28, wherein the eccentric point does not coincide with the first midpoint.

30. The imaging lens driving module of claim 19, wherein the first guide rail further has a first surface, the first surface and the second surface are connected and form an included angle, the second guide rail further has a third surface, and the third surface and the fourth surface are connected and form an included angle; and
wherein the first surface and the fifth surface are parallel to each other, and the third surface and the seventh surface are parallel to each other.

31. The imaging lens driving module of claim 19, wherein an angle between the fifth surface and the sixth surface is θ₅₆, an angle between the seventh surface and the eighth surface is θ₇₈, and the following conditions are satisfied:
$$\begin{matrix}π / 2 \leq {θ}_{56} < π ; and \\ π / 2 \leq {θ}_{78} < π .\end{matrix}$$

32. The imaging lens driving module of claim 31, wherein the angle between the fifth surface and the sixth surface is θ₅₆, the angle between the seventh surface and the eighth surface is θ₇₈, and the following conditions are satisfied:
$$\begin{matrix}98 degrees \leq {θ}_{56} < π ; and \\ 98 degrees \leq {θ}_{78} < π .\end{matrix}$$

33. The imaging lens driving module of claim 19, wherein the imaging lens comprises:
a reduced portion trimmed towards the optical axis from a part of the imaging lens, resulting in a non-circular shape of the imaging lens in a direction surrounding the optical axis.

34. A camera module comprising:
the imaging lens driving module of claim 19; and
an image sensor disposed on an image surface of the imaging lens driving module.

35. An electronic device comprising:
the camera module of claim 34.
